(19) United States
(12) Patent Application Publication
(10) Pub. No.: US 2009/0262376 A1
(43) Pub. Date: Oct. 22, 2009

(54) GRAIN PATTERN FOR GRAIN PATTERN PRINTING, METHOD AND PROGRAM FOR CREATING GRAIN PATTERN, AND HOUSING BUILDING MATERIAL PRODUCT, AUTOMOTIVE INTERIOR PART, ELECTRIC HOME APPLIANCE, AND INFORMATION EQUIPMENT WITH GRAIN PATTERN PRINTED THEREON

(76) Inventors: Hideki Aoyama, Kanagawa (JP); Satoshi Nakatsuka, Kanagawa (JP); Hisayoshi Sato, Tokyo (JP)

Correspondence Address: DICKSTEIN SHAPIRO LLP, 1825 EYE STREET NW, Washington, DC, 20006-5403, US

(21) Appl. No.: 12/441,496

(22) PCT Filed: Aug. 31, 2007
(86) PCT No.: PCT/JP2007/067076

§ 371 Date: May 4, 2009

(30) Foreign Application Priority Data
Sep. 15, 2006 (JP) 2006-251125

(51) Int. Cl. H04N 1/60

(52) U.S. Cl. 358/1.9

(57) ABSTRACT

An object of the present invention is to install software in a computer to create a grain that replaces a conventional grain. The present invention provides a grain pattern for grain pattern printing created by a computer, the grain being characterized in that basic structures are repeatedly generated using a geometrical fractal in such a way that the generated basic structures include basic structures with a repetition mode changed.

### TECHNICAL FIELD

The present invention relates to a grain pattern for grain pattern printing created by a computer, a method and a program for creating a grain pattern, and a housing building material product, an automotive interior part, an electric home appliance, and information equipment with a grain pattern printed thereon.

### RELATED ART

Wood products have mostly been used for housing interior materials for wall surfaces, ceilings, floors, and the like, and furniture decoration materials for shelves, doors, and the like. However, with development of printing techniques, new building materials have been formed by taking a photograph of a grain of actual wood, executing image processing on the photograph, printing the photograph on paper, a film, or the like, and laminating the paper or film on plywood so that the resulting building material offers decorative characteristics such as senses of high quality, expensiveness, and valuableness and gives the impression that the building material is made of actual wood.

At present, to make users more satisfied with habitability, designability is positively introduced into image processing, and advanced, complicated, and decorative printing techniques are used to improve the added values of the printing. In English, the printing in this field is called decoration printing. Markets for decoration printing have been expanding throughout the world. Recently, owing to a technique such as water transfer which prints a water-soluble film, immerses the film in water so that only a pattern film floats on the water, presses a plastic product or the like against the pattern film from above to attach the pattern to a surface of the product or the like, the decoration printing has been utilized even for interior materials for industrial products such as automotive interior parts. Furthermore, the decoration printing is expected to be widely applied to commercial-off-the-shelf products such as electric home appliances and information equipment, and industrial materials.

On the other hand, efforts have been made to inhibit the unlimited use of a large amount of wood in view of environmental impacts. This also promotes the utilization of the printing techniques for building materials. In connection with this, attempts have been made to replace not only the interior materials but also exterior materials with alternative ones. The printing techniques have thus been increasingly important. In this case, the prices of the materials need to be reasonable compared to those of the conventional materials. Furthermore, by not only using the alternatives but also applying characteristic designs to, for example, the characteristic grains of woods around the world to enhance the decorative characteristics, requests for the sense of beauty and the comfort of residences can be met. Additionally, the printing techniques are applicable not only to the wood grain but also to the patterns of diverse natural and artificial materials such as the grain of leather, pebble, fabric, and metal, and geometrical abstract patterns. A flowchart in FIG. 1 shows a process of applying the printing techniques to these materials to obtain interior materials or the like. Step 1 shows these objects of the printing techniques.

At present, offset printing, a type of planographic printing, is very often utilized for beautiful color printing. With the offset printing, production of plates is facilitated, production costs are reduced, and operations of, for example, replacing the plate and matching colors are automated to significantly improve operability. Offset printing machines are also more inexpensive than gravure printing machines. As a result, the offset printing is characterized by, for example, facilitating printing in small lots and has thus spread rapidly. However, the printing for the housing building materials relies on a scheme using gravure printing or intaglio printing, which is different from the offset printing. The scheme requires operations associated with a printing process to produce plates, uses an expensive printing machine, and requires a manual operation for plate replacement and appropriate skills for color development and adjustment. As a result, the scheme is disadvantageous in many ways compared to the features of the offset printing; the scheme is unsuitable for the production in small lots.

However, the offset printing uses four color inks in yellow, magenta, cyan, and black. On the other hand, printing for building materials, transfer foils, and the like develops colors by mixing any of the four color inks or using “special color” inks of color tones different from those of the four color inks. Intaglio printing, which is characteristic of the gravure printing, is a scheme of creating cells in a plate surface by a chemical or mechanical method and transferring ink collected in the cells to a target surface, allowing a print result to give a sense of the amount of the ink. This scheme is suitable in terms of the properties of target paper, films, or the like. The scheme is also suitable in terms of the properties of the subsequent steps such as lamination on a plywood surface, a metal surface, or a plastic surface, graining described below, and superimposition on a print surface. For the above-described reasons, the gravure printing is an essential scheme (see Non-Patent Document 1).

[Acquisition of Image Data]

According to a traditional technique, a photograph of a target such as a wood grain, which is decorative and suitable for building materials, is taken and immobilized to a film, which is then utilized for printing. Under these circumstances, data is processed in an analog manner. Recently, digital cameras have commonly been utilized to acquire images in the form of digital data. Furthermore, a scanner with a digital camera enables photographs of long or large objects to be taken. Also, in this case, images are acquired in the form of digital data. Both the analog and digital data acquired is processed into original data on a pattern to be printed as shown in step S2 in FIG. 1. This operation is performed by operating block 1.

Traditional photographing with a camera is performed by a camera operator based on the operator's technique. A scanner, which is easily operable, is now mostly utilized to acquire data. In this case, during scanning or image pickup, the direction of daylighting is varied to precisely adjust the appearance of annual growth rings, vessels, and the like to acquire data based on the prediction of the printed annual growth rings, vessels, and the like. Then, based on the data acquired, a computer graphics (CG) processing staff member and a finish and retouch staff member perform proper operations. The computer graphics processing staff member examines the repeatability, color tones, continuity, and the like of print patterns in a predetermined area, and the finish and retouch staff member improves quality based on the color tones of the patterns, the wood grain, and the like. At present, these operations are performed by the same person who serves as a creator and who performs the data acquiring operation.

[Grain]

Now, grain will be described. According to Kojien, a famous dictionary of Japanese, the grain refers to “recesses and projections created on a surface of fabric in connection with the manner of twisting of yarns in the fabric, or recesses and projections formed like wrinkles on leather or paper”. In the current printing, general recesses and projections created on the leather, wood, fabric, or metal surface, or geometrical patterns or lines, or pearskin patterns are called as the grain. When an image of a pattern is picked up in the above-described flow, the grain is also contained in the pattern data as an image. FIG. 2 shows various examples of the grain (see 1 to 10 issued by TANAZAWA HAKKOSHA CO., LTD.). The appropriate use of the grain allows print products to be finished so as to give users the impression that the products have recesses and projections though the products actually have no such recesses or projections, and to make users feel like touching the products. Thus, ordinary print products can be provided with the senses of expensive decoration and improved designability to enhance the added values of the print products.

On the other hand, to emphasize a sense of the presence of recesses and projections, a separate graining section is established to create and use appropriate dies to form recesses and projections (embossing) on a surface of a printed material processed with resin and bonded to plywood or a surface of a printed plastic material such as vinyl chloride to enhance the added value of the corresponding product. In natural materials, the grain is integrated with a pattern such as a wood grain. However, for conventional building material products, a pattern is printed on the product, while a grain matching the pattern is not particularly taken advantage of. The use of recesses and projections matching a print pattern is conventionally not necessarily required even after enabling of embossing, and even an embossed pattern seemingly matching the print pattern is accepted.

However, products have been presented which are provided with recesses and projections by embossing in sync with a basic pattern such as a wood grain. Such embossing is called in-sync embossing. With this technique, printing and embossing need to be performed so as to match the pattern. This in turn requires, for example, advanced techniques for achieving complicated design of a pattern for a printed product and advanced printing and finishing techniques for achieving the in-sync embossing. Additionally, dies are produced based on leather grain and used to create the corresponding pattern on a surface of a resin material. The resulting material is utilized for interior parts such as a dashboard and seats as an automotive interior decorative material (facing material). Additionally, the grain is expected to utilize for a facing material of electric home appliances and information equipments.

[Process of Creating a Pattern for Printing]

In step S3 in FIG. 1, a creator and a designer who is joined to examine the designability of the pattern use a screen of a computer output display device to determine whether or not a portion of the original data acquired in step S2 which is appropriate to printing is repeatable, how the wood grain is emphasized, the feel of the wood grain such as the shading and arrangement of the wood grain, how to modify the feel, how the data is colored, and fashionability of the pattern design. The creator and the designer thus create sample data to be presented to a client. During this process, an ink jet printer outputs the data to paper in step S4. In step S5, the creator and designer determine whether or not the finished pattern is acceptable. In the subsequent step S6, an A3-plus baby is used to color the pattern, and the resulting pattern is checked based on correlation with the printing output from the ink jet printer. The number of repetitions of block 2 is preferably minimized. However, at present, the repetition of block 2 is expected to be unavoidable.

For the print pattern, the small rotary printing machine called the quarto baby performs printing using inks of which the number is the same as that of colors used in the ink jet printer. Thus, the printed sample is presented to the client for acceptance. Depending on requests from a client designer who is in charge of actual interior design, verification is repeated in block 3, before the ink jet machine performs printing in step S8.

The above-described flow may involve the pattern corresponding to the grain. However, if grain dies are expected to be produced in the subsequent step S9, step S9 is separately carried out by an external company. Thus, close cooperation with the related external company is required. In particular, for the in-sync embossing, the pattern on the printed product may be deformed owing to the properties of the printed material such as paper, the properties of the ink, tension applied during printing, and the like. As a result, the pattern on the printed product may be deformed compared to a pattern created on the plate. Thus, to allow the printed product to be embossed in sync with the pattern on the plate, the pattern needs to be varied for die production with the possible deformation taken into account. This requires advanced techniques. Non-Patent Document 1: “Color Printing” in “Production Evolution Theory”, vol. 1 (2001), pp: 84-87, NIKKAN KOGYO SHINBUN, LTD.

### DISCLOSURE OF THE INVENTION

As described above, the grain is conventionally created by realistically collecting data from the actual natural or artificial material and using the data for printing and decoration. The grain has sometimes been created by relying on the technician's skills. However, even in this case, the grain has generally been created by the above-described process.

On the other hand, with the improved performance of computers and increasing demands for techniques for utilizing the advanced computers, attempts have been started to create patterns with improved designability with support of the computers. An object of the present invention is to install software in a computer to create a grain that replaces the conventional grain.

A grain pattern for grain pattern printing according to the present invention is created by a computer and advantageously solves the above-described problems. The grain pattern is characterized in that basic structures are repeatedly generated using a geometrical fractal in such a way that the generated basic structures include basic structures of which a repetition mode is changed.

The basic structure may be a branch structure. The change of the repetition mode may be single replacement, reverse single replacement, or double replacement corresponding to a combination of the single replacement with the reverse single replacement. Furthermore, dead-end branch element lines of the branch structures may be removed to create a corrugated shape.

Moreover, a 1/f fluctuation characteristic may be applied to positions of lattice points coupling the basic structures together. Alternatively, the 1/f fluctuation characteristic may be applied to at least one of element line length and element line inclination of each of the basic structures.

Moreover, the grain pattern may have a width and a depth based on the number of times that the basic structures are superimposed on each other.

Furthermore, a method of creating a grain pattern for grain pattern printing using a computer according to the present invention is characterized by comprising a base structure generating step of using a geometrical fractal to generate a basic structure, and a basic structure repeating step of repeatedly generating the basic structures in such a way that the generated basic structures include basic structures of which a repetition mode is changed.

In the method of creating the grain pattern for grain pattern printing according to the present invention, the basic structure may be a branch structure. The change of the repetition mode may be single replacement, reverse single replacement, or double replacement corresponding to a combination of the single replacement with the reverse single replacement. Furthermore, dead-end branch element lines of the branch structures may be removed to create a corrugated shape.

Moreover, a 1/f fluctuation characteristic may be applied to positions of lattice points coupling the basic structures together. Alternatively, the 1/f fluctuation characteristic may be applied to at least one of element line length and element line inclination of each of the basic structures.

Moreover, the grain pattern may have a width and a depth based on the number of times that the basic structures are superimposed on each other.

Moreover, in the basic structure generating step, a plurality of types of basic structures may be generated and presented so that one type of basic structures is selected for use. Alternatively, in the basic structure repeating step, a plurality of types of basic structures with changed repetition modes may be generated and presented so that one type of basic structures with the changed repetition mode is selected for use.

Moreover, the grain pattern created by the above-described creation method may be subjected to two-dimensional Fourier transformation to obtain a power spectrum picture, and the power spectrum picture may be presented so that based on a result of evaluation of the power spectrum picture, the created grain pattern is output. Alternatively, information entropy is obtained from the grain pattern created by the creation method and presented so that based on a result of evaluation of the information entropy, the created grain pattern is output.

Moreover, a program for creating a grain pattern for grain pattern printing according to the present invention allows a computer to create grain pattern and is characterized by comprising a base structure generating step of using a geometrical fractal to generate a basic structure, and a basic structure repeating step of repeatedly generating the basic structures in such a way that the generated basic structures include basic structures of which a repetition mode is changed.

Moreover, the program for creating the grain pattern for grain pattern printing according to the present invention may further comprise a step of presenting a plurality of types of basic structures generated in the basic structure generating step, and a step of inputting a selected type of basic structures. Alternatively, the program for creating the grain pattern for grain pattern printing according to the present invention may further comprise a step of presenting a plurality of types of basic structures with changed repetition modes which are generated in the basic structure repeating step, and a step of inputting a selected type of basic structures with the changed repetition mode.

Moreover, the program for creating the grain pattern for grain pattern printing according to the present invention may further comprise a step of subjecting the grain pattern created by the above-described creation method to two-dimensional Fourier transformation to obtain a power spectrum picture, a step of presenting the power spectrum picture obtained, and a step of inputting a result of evaluation of the power spectrum picture, wherein based on the evaluation result, the created grain pattern is output. Alternatively, the program for creating the grain pattern for grain pattern printing according to the present invention may further comprise a step of obtaining information entropy from the grain pattern created by the creation method, a step of presenting the information entropy obtained, and a step of inputting a result of evaluation of the information entropy, wherein based on the evaluation result, the created grain pattern is output.

A housing building material product, an automotive interior part, an electric home appliance, and information equipment according to the present invention are characterized in that the above-described grain pattern is printed thereon.

When the computer creates the grain pattern according to the present invention, steps S1 and S2, related to block 1 in FIG. 1, may be incorporated into steps S3 and S4, related to block 2. Thus, arrangements can be made which deal with the trend of markets, that is, an increasing demand for a reduction in delivery period. This measure gives a company an upper hand over competitors. Furthermore, the operations in steps S3 and S4 mean that not only the creator but also the designer can be involved in creation of the grain pattern. Various grain patterns with perfectly new designs can thus be created based on natural materials. Consequently, the printing techniques can be used to provide building materials expected to find potential clients.

When the computer creates the grain pattern according to the present invention, the computer generates a plurality of types of basic structures and presents the basic structures to the creator and the designer by, for example, displaying the basic structures on a screen. The creator and the designer then interactively select a preferable type of basic structures to give (input) a relevant instruction to the computer so that the computer can use the selected type of basic structures. Alternatively, the computer generates a plurality of types of basic structures with changed repetition modes during the basic structure repeating step and presents the basic structures to the creator and the designer by, for example, displaying the basic structures on the screen. The creator and the designer then interactively select a preferable type of basic structures with the changed repetition mode to give (input) a relevant instruction to the computer so that the computer can use the selected type of basic structures with the changed repetition mode. Thus, the creator and the designer can be more easily and positively involved in the creation of the grain pattern.

Moreover, when the computer creates the grain pattern according to the present invention, the grain pattern created by the above-described creation method is subjected to two-dimensional Fourier transformation to obtain a complex plane-like Fourier coefficient spectrum. The Fourier coefficient spectrum is then presented to the creator and the designer by, for example, being displayed on the screen. The creator and the designer then interactively evaluates the Fourier coefficient spectrum based on a characteristic pattern generally expected to provide a preferable grain pattern, and gives (inputs) a relevant instruction to the computer. The computer then outputs the created grain pattern determined to be preferable based on the evaluation result. Thus, the computer can selectively output the grain pattern expected to be preferable for the users.

Furthermore, the technique of creating the grain using the geometrical fractal may be to provide information on the width of the grain and on the corresponding depth of the grain based on the number of times that the basic structure is repeatedly generated, that is, three-dimensional information. In the conventional art, since recesses and projections are generated on a print surface by embossing, production of dies for the grain pattern during the subsequent steps relies mainly on a photo etching technique based on grain pattern data. However, when the grain data originally includes shape data such as the width and depth, the data can be immediately used as machining information. Thus, input information required for production of a male die and a female die can be transferred to an NC machine tool, and processing can then be immediately started. This contributes to reducing the amount of time required to produce the dies. The above-described process can be easily realized because the processing performance of the machine tool, including the rotation number of a spindle, has recently been significantly improved, with the performance of tools also improved. For the photo etching, whether or not to etch a certain part has been determined using a mask. However, a method using laser irradiation scanning is now available and is expected to apply to the photo etching.

### BRIEF DESCRIPTION OF THE DRAWINGS

FIG. 1 is a flowchart showing a flow of conventional pattern printing;

FIG. 2 is a diagram illustrating examples of grains;

FIG. 3 is a diagram illustrating examples of fractal structures in nature;

FIG. 4 is a diagram illustrating an example of an algebraic fractal;

FIG. 5 is a diagram illustrating an example of a geometrical fractal (Koch curve);

FIG. 6 is a diagram illustrating a generator for the Koch curve and creation of a fractal;

FIG. 7 is a diagram illustrating an example of a branch structure generator;

FIG. 8 is a diagram illustrating replacement growth of the branch structure generator;

FIG. 9 is a diagram illustrating that the generator is changed by removing branch element lines;

FIG. 10 is a diagram illustrating examples of replacements performed by the changed generator;

FIG. 11 is a flowchart showing a flow of creation of a grain element;

FIG. 12 is a diagram illustrating the length and inclination of the element line;

FIG. 13 is a flowchart showing a flow of construction of lattice points and application of a fluctuation characteristic;

FIG. 14 is a diagram illustrating an example of an arrangement rule and a concatenation rule for the lattice points;

FIG. 15 is a diagram illustrating examples of leather grains;

FIG. 16 is a relationship diagram showing the fluctuation characteristic based on a power spectrum density function;

FIG. 17 is a diagram illustrating the fluctuation characteristic of a wood grain (camphor tree);

FIG. 18 is a diagram illustrating the fluctuation characteristic of a wood grain (redwood);

FIG. 19 is a diagram illustrating the concept of application of a “1/f fluctuation” to a first lattice point;

FIG. 20 is a diagram illustrating the concept of application of the “1/f fluctuation” to a second lattice point;

FIG. 21 is a flowchart showing a flow of application of the fluctuation characteristic;

FIG. 22 is a diagram illustrating an example of a grain pattern with grain elements consecutively arranged therein;

FIG. 23 is a diagram illustrating the grain pattern obtained when the fluctuation is applied to the first lattice point;

FIG. 24 is a diagram illustrating the grain pattern obtained when the second lattice point is introduced;

FIG. 25 is a diagram illustrating the grain pattern obtained when the fluctuation is also introduced into the generator;

FIG. 26 is a relationship diagram showing the results of verification of the “1/f fluctuation characteristic”;

FIG. 27 is a flowchart showing a flow of creation of a grain pattern;

FIG. 28 is a diagram illustrating a method of generating a film utilizing photo etching;

FIG. 29 is a flowchart showing a flow of creation of a grain element:

FIG. 30 is a flowchart showing another flow of application of the fluctuation characteristic to the generator;

FIG. 31 is a diagram illustrating a concept of a model for converting a segment into a rectangle;

FIG. 32 is a diagram showing a smoothing method based on a connection deforming segment;

FIG. 33 is a diagram illustrating a smoothing method based on movement of the segment;

FIG. 34 is a flowchart showing a program based on a method of interactively making a grain design;

FIG. 35 is a perspective view of a surface pattern characterized by varying in two directions;

FIG. 36 is a diagram illustrating contours of the surface pattern;

FIG. 37 is a diagram illustrating characteristic lines obtained by abstracting the contours of the surface pattern;

FIG. 38 is a perspective view showing a region of a two-dimensional Fourier coefficient;

FIG. 39 is a perspective view showing the region in which the two-dimensional Fourier coefficient is present and the surface pattern;

FIG. 40 is a perspective view showing a Fourier spectrum for the surface pattern in FIG. 39;

FIG. 41 is a perspective view showing a Fourier coefficient spectrum for the surface pattern in FIG. 35;

FIG. 42 is a perspective view showing a Fourier spectrum for FIG. 35 obtained from the Fourier coefficient spectrum in FIG. 41;

FIG. 43 is a flowchart of a method of evaluating characteristics of a created pattern;

FIG. 44 is a flowchart of a process of determining whether or not to adopt a created grain pattern, based on extraction of the characteristics of a practical grain pattern using the two-dimensional Fourier analysis and on variable adjustment;

FIG. 45 is a diagram illustrating comparison between grain images and results of the two-dimensional Fourier analysis of the grain images;

FIG. 46 is a diagram illustrating comparison between grain images and results of the two-dimensional Fourier analysis of the grain images;

FIG. 47 is a diagram illustrating comparison between grain images and results of the two-dimensional Fourier analysis of the grain images; and

FIG. 48 is a flowchart showing how to utilize analysis of main components and calculation of information entropy for evaluation.

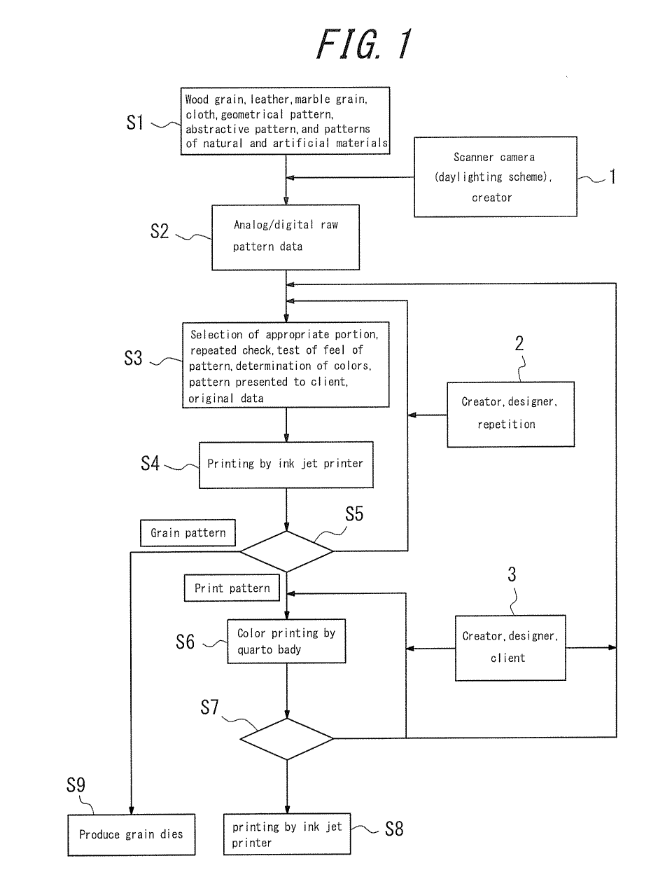

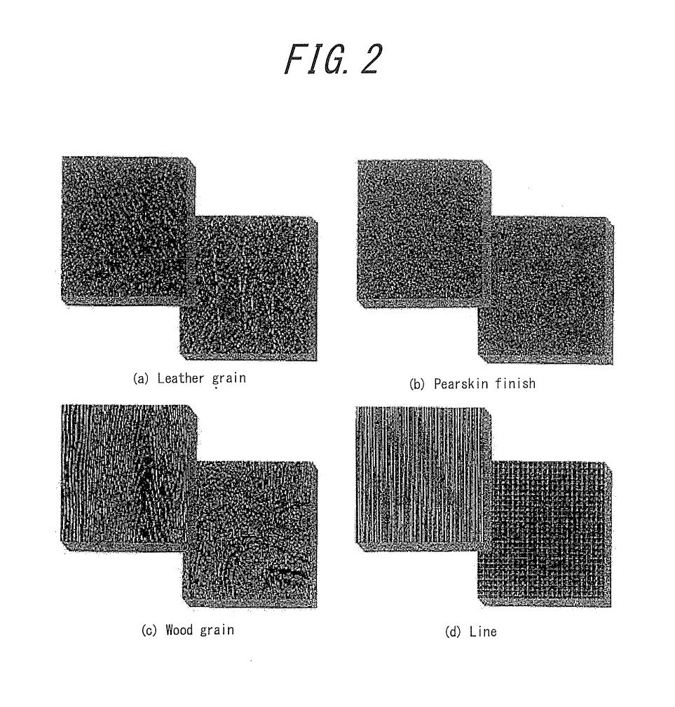

### BEST MODE FOR CARRYING OUT THE INVENTION

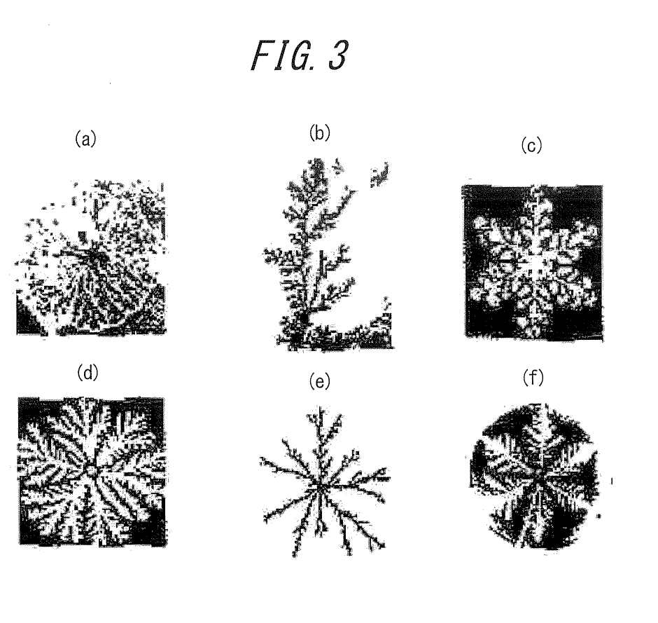

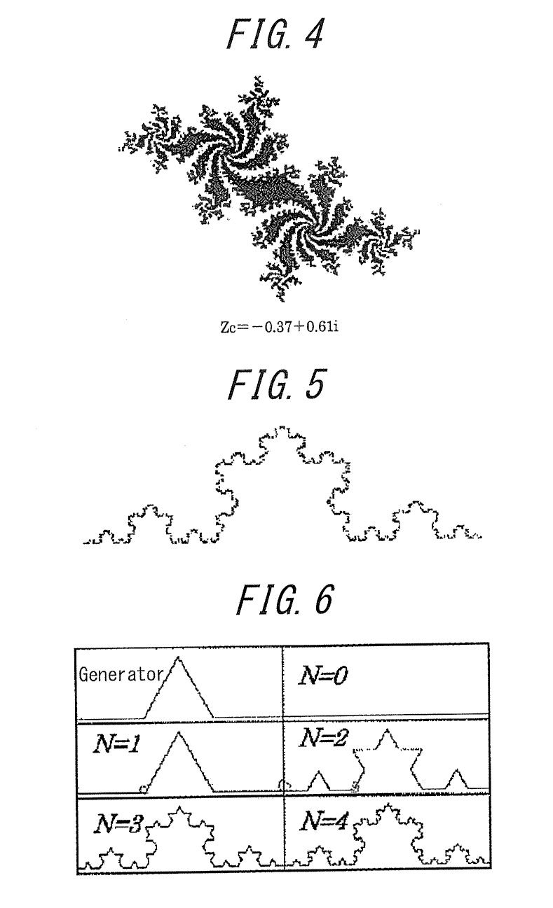

An embodiment of the present invention will be described below in detail with reference to the drawings by taking appropriate examples. The embodiment described below is implemented by a program pre-installed in an ordinary computer or a program fed into the computer by an external storage medium. FIG. 3 shows examples of naturally observed fractal structures. Each of the fractals grows structurally. A growth process of the fractal is associated with a probability phenomenon. The fractal generates similar shapes. Thus, these fractals are classified as stochastic fractals (see “Fractal Growth Phenomenon” authored by T. Vicsek and issued by Asakura Publishing Co., Ltd in 1990.). FIG. 4 shows examples classified as algebraic fractals (see “Travels among Fractals” authored by Hiroshi SERIZAWA and issued by Morikita Publishing Co., Ltd. in 1993).

The algebraic fractal is generated on a complex plane. When a complex sequence {Zn} is expressed by:

### [Formula 1]

Zₙ=Xₙ+Yₙ·I(Xₙ and Yₙ are real numbers and i is a complex unit) (1),

Zₙ is expressed by a point Pₙ(Xₙ, Yₙ). In this case, {Zₙ} generates a point sequence Pₙ on an (X, Y) plane. A recurrence formula of the complex sequence is expressed by:

### [Formula 2]

Zₙ=f(Zₙ−1)(n=1, 2, 3, . . . ) (2).

Pₙ₋₁(Zₙ₋₁) determines Pₙ(Zₙ), enabling Zₙ to be subsequently sequentially determined for all ns in a recursive manner.

Here, when n→∞, the point sequence exhibits one of the following four types of behavior.

1. The point sequence row converges to one point.
2. The point sequence vibrates periodically among a finite number of points.
3. The point sequence moves within a certain region.
4. The point sequence diverges.
The behavior is determined by the shape of the numerical sequence of Formula (2) and an initial value Z₀.

FIG. 4 shows the result of expression of the relationship exhibited by:

### [Formula 3]

Zₙ=Z₍ₙ₋₁₎²+Z_{c} (3).

Formula (3) used as a recursive formula with all the points in a specified region set to the initial value and with diverging points and non-diverging points expressed in black and white, respectively.

The above-described algebraic and stochastic fractals typically illustrate what the fractals are. However, assuming leather as a typical example of a grain and associating the leather with a fractal is difficult. Furthermore, in connection with design, determining the shape of the fractal in FIG. 4 based on a relational expression shown in the same figure is almost impossible.

As described above, the present invention considers a geometrical fractal composed of segments to be suitable for creation of a grain and thus utilizes the geometrical fractal; self-similarity, which is characteristic of the geometrical fractal, is easy to determine, and the geometrical fractal is a simple graphic. FIG. 5 shows an example of a geometrical fractal called a Koch curve. The geometrical fractal is generated by defining, as a basic structure, a geometrical shape composed only of segments called a generator and repeating, a plurality of times, an operation of replacing each of all the segments (element lines) making up the generator with a shape similar to that segment. FIG. 6 shows a process of creating the Koch curve. Here, N denotes the number of replacements.

[Branch Structure Fractal]

An embodiment of the present invention provides a grain creating system using a branch structure fractal as a geometrical fractal. The grain structure of leather is assumed as a typical grain structure. However, a construction method according to the present invention can be carried out in various manners using the generator.

With the algebraic and stochastic fractals, estimating a relationship between an initial basic formula and a picture corresponding to a pattern to be created based on the formula is almost impossible. On the other hand, with the geometrical fractal, the generator can be optionally varied through interactions with the computer. Moreover, grain shapes based on the varied generator can also be viewed on the screen. The designer can then create the grain by repeating appropriate operations while determining the relationship between the generator and the grain shape, to check and determine the designability, naturalness, diversity, and the like of the resulting grain. In this case, the characteristics of the grain are designed with a relationship with the print pattern taken into account. Furthermore, the grain is independently designed with the designability thereof enhanced.

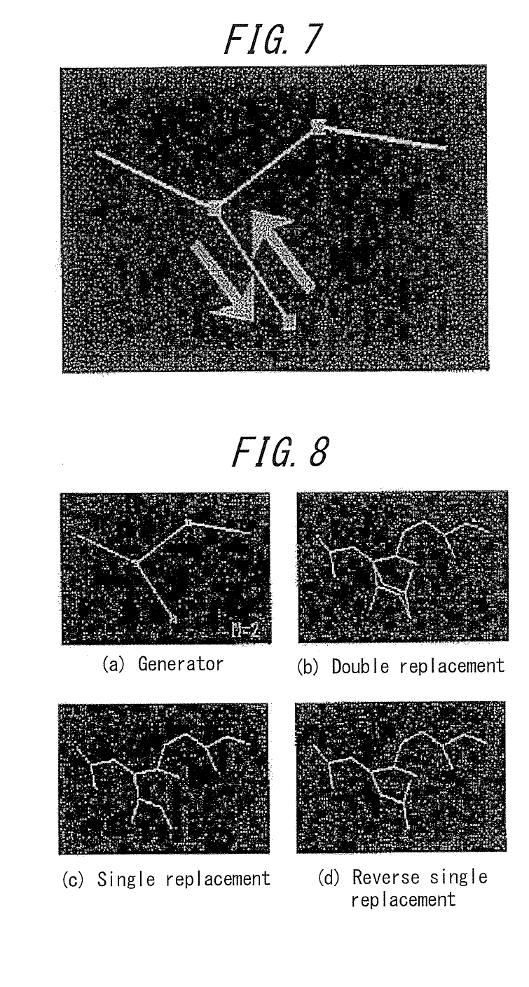

FIGS. 7 and 8 show an example of a branch structure generator and several types of replacement and growth of the generator. With the branch structure fractal, the generator needs to be unicursal. The generator shown in FIG. 7 involves branching and is thus not unicursal at the branch portion. Consequently, the branch portion is reciprocatingly drawn as shown by arrows. FIG. 8 shows that the branch portion is replaced with one of the outward route and the homeward route, with the other neglected and that the replacement is carried out on each of the element lines. FIG. 8(b) shows double replacement in which the branching portion is replaced in both the outward and homeward directions. FIG. 8(c) shows single replacement in which the branching portion is replaced only in the outward direction. FIG. 8(d) shows reverse single replacement in which the branching portion is replaced only in the homeward direction.

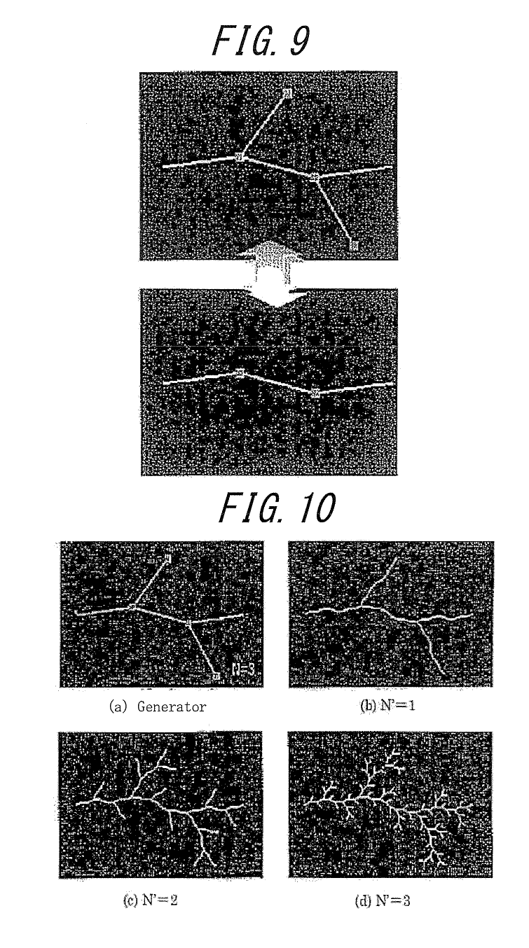

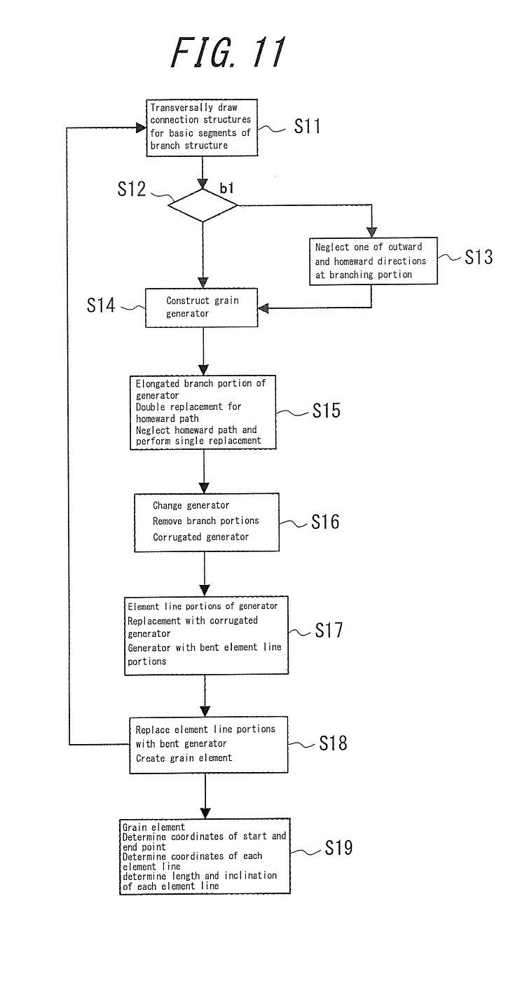

For the branch structure, the amount of branching and the complexity of the structure increase consistently with the number of replacements. FIGS. 9 and 10 show an example of a technique of removing the branching element lines from the original generator to obtain a new generator and replacing the new generator in a certain replacement stage for the original generator, in order to separately control the complexity and the amount of branching. FIG. 9 shows an example in which branching element lines are removed from a branch structure generator to form a new corrugated generator. FIG. 10 shows that in a first stage for the original branch structure, the changed generator is replaced such that the element lines thereof are corrugated to increase the complexity of the structure. The corrugated structure is then used as a generator and subjected to subsequent replacements to successfully create a complicated branch structure. When buried between lattice points described below, the branch structure obtained as described above is called a grain element. FIG. 11 shows a flow of creation of a grain element including a procedure following the above-described one, which is shown as steps S11 to S19.

The generators in FIGS. 7 and 9 can be created on the screen of the computer display device by utilizing a GUI (Graphical User Interface) and operating a mouse. Although depending on the characteristics of the geometrical fractal, this easy operation allows a relationship between the generator and the grain element to be easily determined. Thus, designs can be created by easy operations. In step S19 in FIG. 11, the start and end points of the generator, divisions for the element line configuration, the start and end points of each element line, and the like are defined on coordinates. A length and an inclination are set for each element line to quantify the grain element. Consequently, the element can be buried between the grip points, described below, to construct the entire grain.

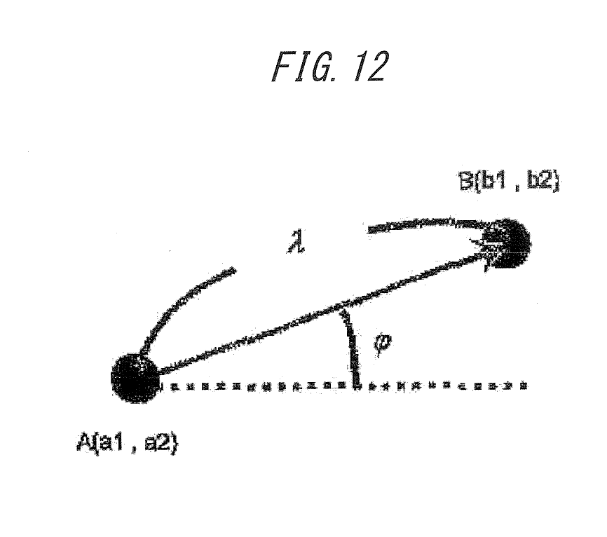

FIG. 12 shows a relationship between the length and inclination of an element line observed when the coordinates of the element line are determined. When the start and end points of the element line are defined as A(a₁, a₂) and B(b₁, b₂), the length λ and the inclination φ of the element line is determined by:

### [Formula 4]

λ=√(a₁−b₁)²+(a₂−b₂)² (4)

φ=arc tan{(a₂−b₂)/(a₁−b₁)} (5).

These characteristics can be used not only for the element lines but also for the start and end points of the element. Since the two directions, that is, the forward and backward directions are assumed for the burial of the grain element, the inclination is φ around A for A→B and is φ-(π/2) around B for B→A.

[Lattice Points Required to Construct the Entire Grain]

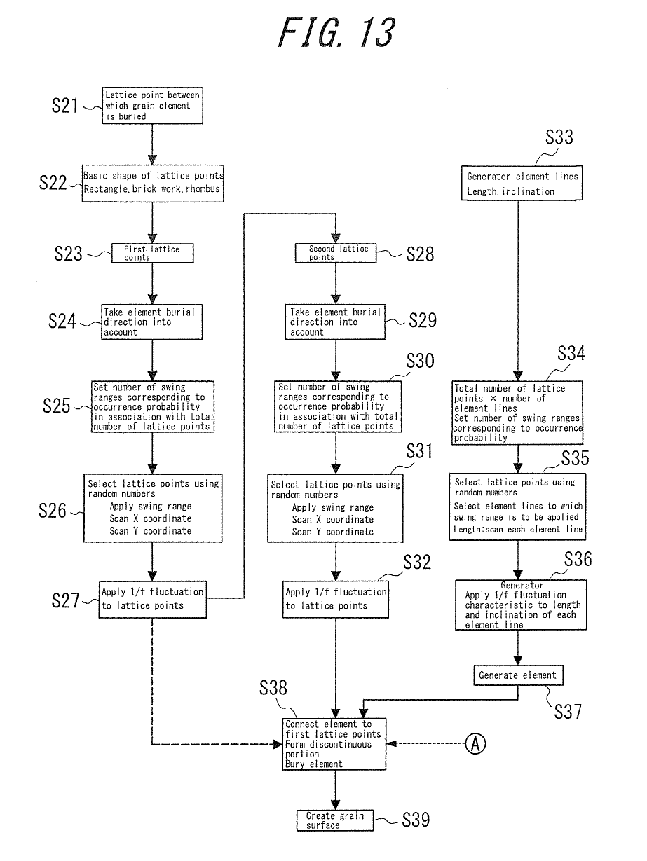

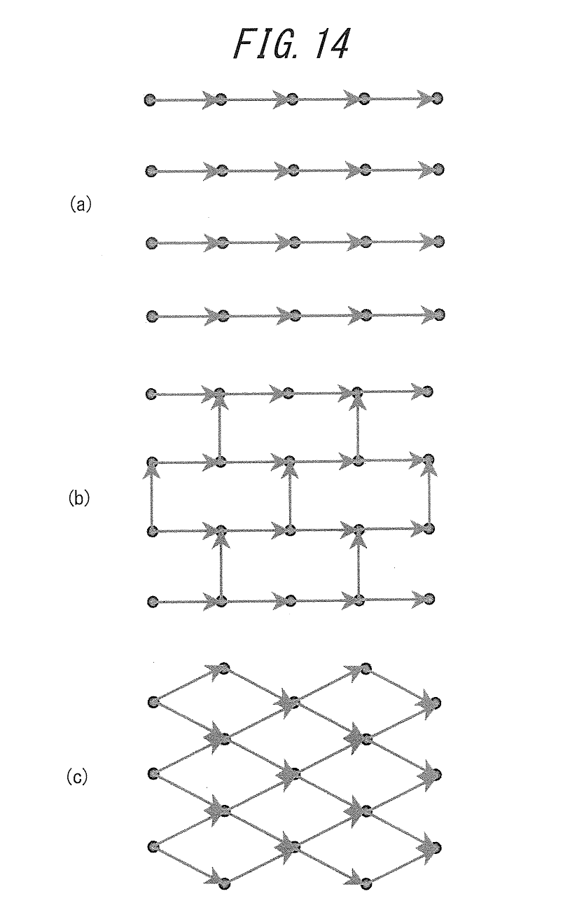

Basically, for expansion of the grain element into a pattern, the grip points are set and the grain element is buried between the lattice points to construct a plane. The lattice points may be arranged in the form of a rectangle, brick work, a rhombus, or the like. FIG. 13 shows a flow of relevant operations including those required to apply a 1/f fluctuation characteristic to the grip points. First, an example of the arrangement of the lattice points is graphically shown in FIG. 14. FIG. 14(a) shows a rectangular arrangement, FIG. 14(b) shows a brick work-like arrangement, and FIG. 14(c) shows a rhombus-like arrangement. The lattice points are initially regularly set as shown in FIG. 14. Thus, the grain constructed by burying the grain element between the lattice points unavoidably makes up a regular pattern.

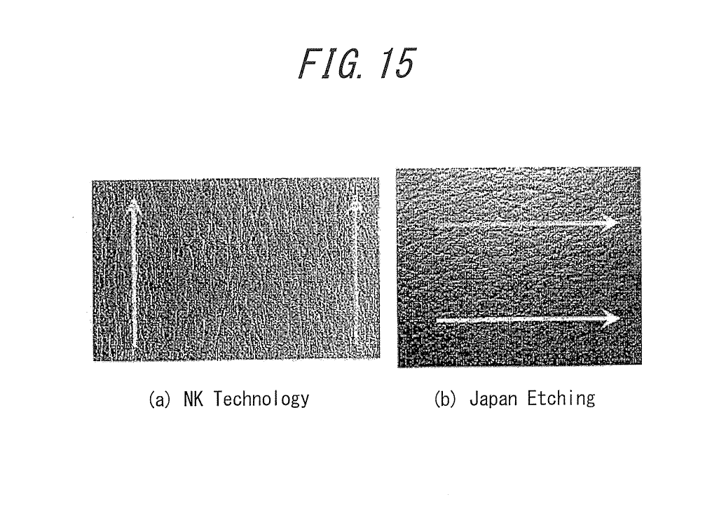

FIG. 15 shows an example of a leather grain. As seen in the example, the grain patterns fail to exhibit ordered regularity. However, the patterns exhibit unique characteristics. The embodiment of the present invention uses the “1/f fluctuation” characteristic to exhibit such characteristics. The fluctuation is applied to the positions of the lattice points and the segment lengths and inclinations of the generator element lines as a swing range to provide the pattern with a sense of complication so that the pattern is similar to the actual grain pattern. As seen in the examples shown in FIGS. 15(a) and 15(b), the leather grain seemingly has an irregular shape. However, the leather grain obviously offers directionality, shown by arrows in the figure. Also in a created grain, long sides of the rectangle are provided with the directionality. The branch structure thus also makes up a pattern characterizing the directionality.

[1/f Fluctuation Characteristic]

Phenomena in nature generally have the property of exhibiting irregularity even in a basic periodicity. Here, f denotes a frequency or the reciprocal of a period. When time and length are used as units, the frequency is the number of vibration with respect to the time and is the number of repetitions over a predetermined length with respect to the length. Fourier analysis is a technique of analyzing the characteristics of a natural phenomenon in association with the frequency. A common Fourier analysis technique allows the characteristics to be analyzed by determining an energy density at each frequency over the entire target frequency region to obtain a power spectrum density function.

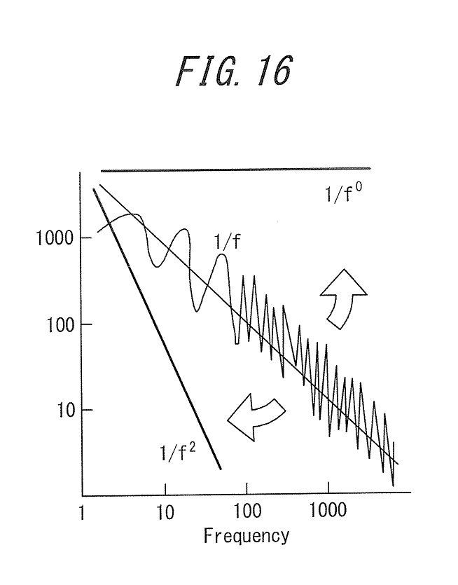

When current is passed through an electric conductor, a noise current with an irregularly varying waveform is observed in a resistance output. In this case, the Fourier analysis technique is applied to a variation in voltage value to determine the power spectrum density function. Furthermore, the frequency and the power spectrum density function are plotted on respective logarithmic axes; the axis of abscissa indicates the frequency, and the axis of ordinate indicates the power spectrum density function. As a result, a characteristic exhibiting the tendency of 1/f is obtained (see Journal of Applied Physics, vol. 58 (1989), No. 12, pp: 1688-1695 “Physics of 1/f Fluctuation”, Toshimitsu MUSHA and Kazuo KITAHARA). FIG. 16 conceptually shows a relationship between the power spectrum density function and the “1/f fluctuation” according to the present invention. The characteristics are distinguished from one another by the power index of f.

The characteristic of f⁻¹, that is, 1/f, has a gradient of −45° on both logarithmic coordinate axes. In contrast, the characteristic with the index 0 is uniform with respect to the frequency. The characteristic with the index −2 is as shown by 1/f² in FIG. 16. The former characteristic corresponds to the case of what is called white noise and exhibits a significant irregularity. On the other hand, the latter characteristic is such that the spectrum density decreases with increasing frequency and such that the resulting pattern is unnoticeable.

Data observed for an analysis target is, in the case of heart rate described below, a variation in heart rate with respect to a time axis or elapsed time, or in the case of a wood grain, a variation in shading in association with the length (see the technique of reproducing a crack in china using the fluctuation in the “World of Fluctuation” issued by Kodansha in 1987 and authored by Toshimitsu MUSHA). When expressed by a waveform, the variation can be considered to be an irregular vibration phenomenon. Provided that the irregular vibration phenomenon is expressed by the waveform, in general, the amplitude varies and is thus difficult to determine, and the frequency is also difficult to read. The reason for using 1/f for definition of the “fluctuation” is unknown. However, in connection with the above-described characteristics of the irregular vibration, the property of exhibiting an unfixed amplitude and an inconstant frequency is expressed as the “fluctuation”.

The characteristic of the 1/f fluctuation is observed not only in the above-described noise voltage but also in the heart rate and annular rings in a wood grain. Furthermore, the possibility that the characteristic offers naturalness, peacefulness, and comfort has been suggested. Moreover, in connection with this, the characteristic is expected to offer a sense of beauty. Specifically, the possibility has been suggested that a crack in china, which is a traditional craft, can be simulated and reproduced by introducing the fluctuation into a basic pattern (see Journal of Information Processing Society of Japan, 2000-35 (2000), pp: 25-28, “CG of Penetration Pattern in China).

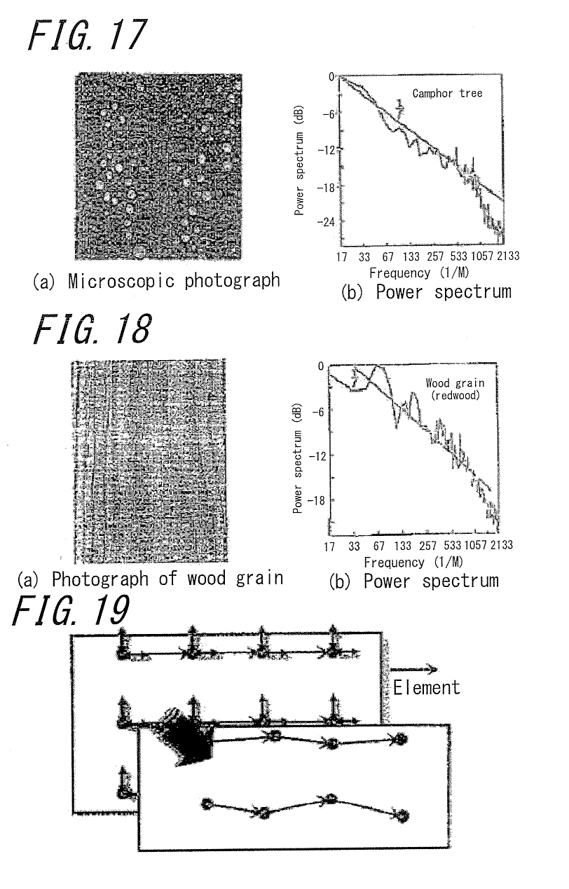

FIGS. 17 and 18 show examples of the characteristic in the case of a wood grain. FIG. 17 shows a microscopic magnified photograph of a wood grain of a camphor tree and a power spectrum indicating the shading in a transverse section. FIG. 18 shows a wood grain of redwood proper which is native to the U.S. and a power spectrum indicating that the wood grain exhibits a similar characteristic. Both figures indicate that the frequency of interest, in this case, the period, exhibits the “1/f fluctuation” characteristic. Whether or not this property applies to all of various woods remains to be seen. However, the figures indicate that the wood grains of certain woods exhibit the 1/f characteristic.

[Occurrence of the “1/f Fluctuation” Characteristic]

The “1/f fluctuation” is introduced not only to disturb the regularity of the structure to complicate the structure but also to apply naturalness and diversity to the pattern. The “fluctuation” is introduced by applying a swing range defining the “fluctuation” to the lattice points, or providing a second lattice point in addition to an initially provided first lattice point and similarly introducing the fluctuation into the second lattice point, or cutting the grain element between the first and second lattice points so as to form a generally discontinuous structure so that the grain as a whole exhibits high diversity and complicatedness, or applying a swing range for a similar characteristic to the lengths and inclinations of the element lines of the generator so as to further enhance the complicatedness.

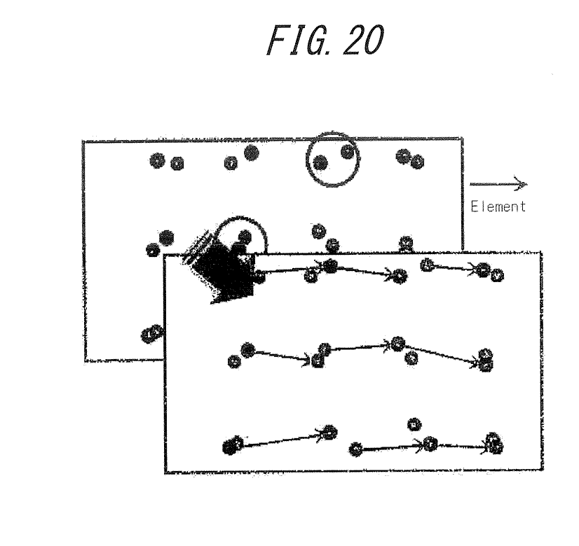

FIG. 19 is a conceptual drawing showing that the “1/f fluctuation” is applied to the lattice points. It is assumed that the grain element is buried between the lattice points so as to create a general grain pattern. An amount of fluctuation is applied to the lattice points by means of a swing range for coordinate values x and y. FIG. 20 is a conceptual drawing showing that the swing range is provided by setting the second lattice point. When the minimum and maximum values of the swing range are defined as fmin and fmax and the number of divisions determining the steps of the swing range between the minimum and maximum values is defined as N, the value of the swing range is given by:

### [Formula 5]

fi=−fmin+{(fmax−fmin)/N} (6)

where 0≦i≦N and i is a natural number. In connection with the 1/f characteristic, a relationship between the value of the swing range and the frequency of occurrences is expressed by:

### [Formula 6]

log₁₀y=−log₁₀fᵢ (7)

where y denotes the frequency, that is, the frequency is expressed by:

### [Formula 7]

y=1/fi (8).

A total frequency S is given by:

### [Formula 8]

S=Σ(1/fi) (9).

An occurrence probability pi for i=n is given by:

### [Formula 9]

pi=fn/S (10).

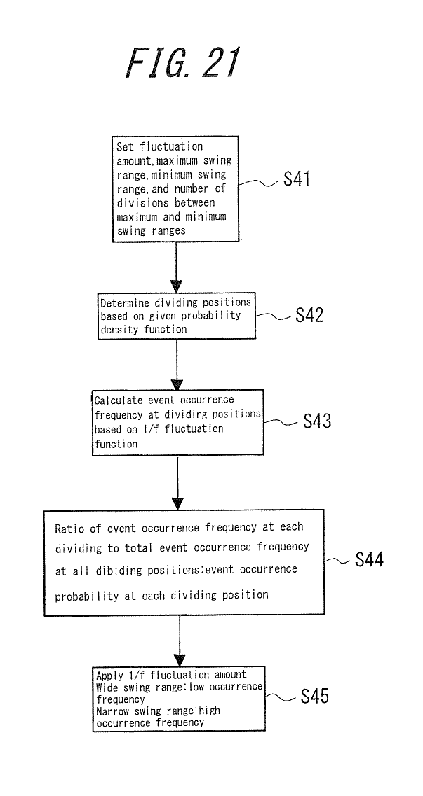

After the lattice points are determined, setting fmin=0 allows the swing range from the original position to be determined based on Formula (6). Here, the value of fmax to be set when fmin=0 needs to be determined during a process of putting the grain to practical use. The appropriate length that is smaller than the length between the lattice points needs to be determined. FIG. 21 shows the flow of this process. For the fluctuation, a large swing range corresponds to an infrequently occurring characteristic, whereas a small swing range corresponds to a frequently occurring characteristic.

[Placement of the 1/f Fluctuation Characteristic on the Lattice Points and the Generator Element Lines]

The total number of the lattice points is defined as M, and the lattice points are numbered. In connection with this, M fis are determined based on the above-described process ending with Formula (10), and are numbered. Here, first, random numbers are used to determine lattice points to which a swing range is to be applied. For the x and y coordinates of the lattice point, the x coordinate is first set, and the y coordinate is then set. However, by setting independent random numbers for the x and y coordinates to apply a swing range to the x and y coordinates, all the lattice points can be mutually independently processed. Thereafter, fis are similarly selected using random numbers and placed at the already selected lattice points. Thus, the fluctuation is applied to the lattice points as shown in FIG. 19.

As a result of the application of the fluctuation to the lattice points, the grain element is buried between the lattice points with the directionality maintained to create a grain pattern. However, depending on the shape of the grain element, the resulting pattern may exhibit an excessively pronounced directionality. To correct this, new lattice points are set at the same positions as those of the above-described lattice points and generated by applying the above-described fluctuation swing range to the above-described lattice points, as shown in FIG. 20. Here, the initial lattice points are called first lattice points. The newly generated lattice points are called second lattice points. Thus, the two groups of lattice points with the different fluctuation amounts are prepared.

A point in the first lattice point group and a point in the second lattice point group which have the same number are arranged adjacent to each other. The grain element is buried by using a point from the first or second lattice point group as a left start point and a point from the first lattice point group as a right point. From which of the lattice point groups the left start point is selected depends on a probability value. The selection can be performed using a constant probability value. However, the probability value can be varied based on the numbered lattice points. Furthermore, in the above description, the selection is performed based on the left start point. However, a point from the first lattice point group may always be used as the left start point, whereas a lattice point from the first or second lattice point group is used as the right point so that the probability at which the point is selected from the first lattice point group is the same as that at which the point is selected from the second lattice point group. This allows the grain element to be discontinued in a certain part of the pattern, thus further enhancing the diversity and complicatedness of the pattern to make the pattern appear more natural.

To provide natural and diverse patterns, the swing range of the “1/f fluctuation” can be applied to the segment lengths and inclinations of the element lines of the generator in addition to the lattice points. As is the case with the lattice points, the fluctuation swing range can be applied based on the numbered element lines. Furthermore, the subsequent operations can be performed with the type of the generator limited based on the manner of applying the fluctuation swing range. Alternatively, the pattern can be created such that different generators can be applied to the respective lattice points.

Determination of whether the fluctuation is applied to all or selected ones of the second lattice points and the generator element lines relates to the possibility of combination of the application with the techniques used before the application. However, increasing the number of parameters to which the fluctuation is to be applied is expected to enable the pattern to be made more natural based on the complicatedness, diversity, and the like. This flow is shown in FIG. 21. By using the thus created lattice points and grain elements and burying each of the grain elements between the lattice points, the entire grain can be created.

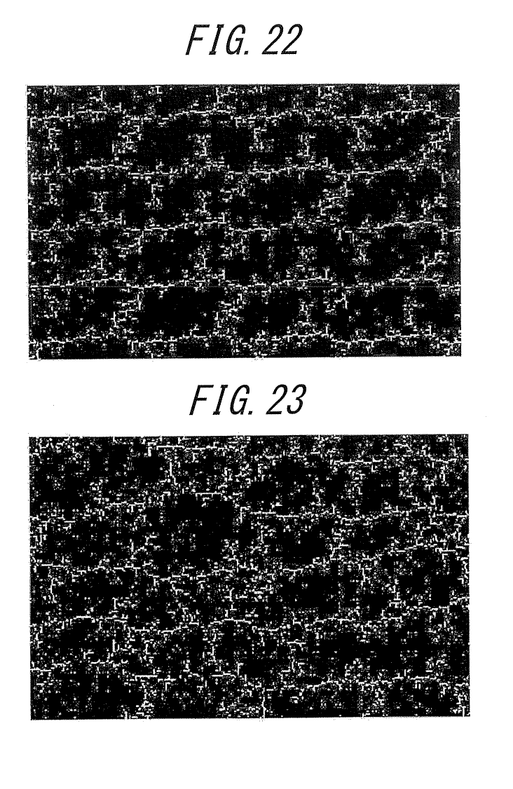

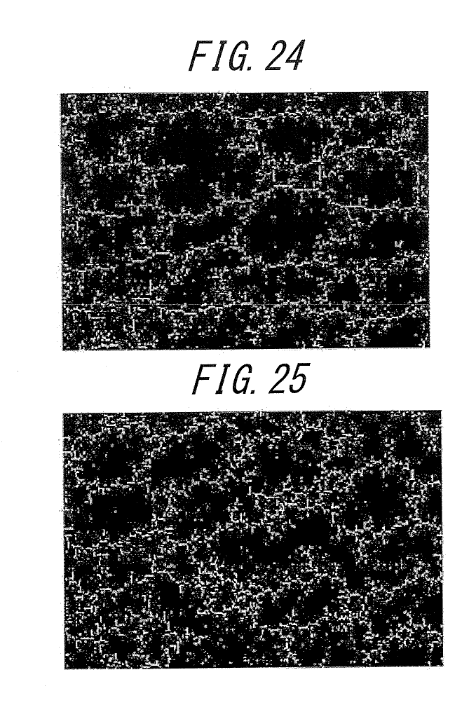

FIGS. 22, 23, 24, and 25 show grain patterns obtained by consecutively arranging the grain elements, applying the fluctuation to the lattice points, introducing the second lattice points, and also applying the fluctuation to the generator, respectively. Which of these methods is selected depends on the specifications of the required housing building material product or the like, the client's preference, or the sensitivity of the creator and designer.

In reality, as shown in the flowcharts described above, the desirable grain pattern can be obtained by, in any intermediate stage including a generator creation stage, returning to the initial stage for corrections, or correcting or modifying portions determined to be corrected or modified based on final results; the corrections and modifications are based on previous practical experience.

[Relational Expression for Burial of the Grain Elements]

The fluctuation swing range has been applied to the lattice points, which have thus been moved from the initial positions thereof. Consequently, the length between the lattice points has been increased from the initial value, with the lattice points rotated. The increase in length and the amount by which the lattice points rotate are determined by Formulae (4) and (5). To be buried between the lattice points, the grain element needs to be able to be enlarged, reduced, and rotated between the start point and end point corresponding to the lattice points. Relational expressions in this case are similar to Formulae (4) and (5) and are as follows:

### [Formula 10]

Iᵢ=√(xᵢ−yᵢ₋₁)²+(yᵢ−yᵢ₋₁)² (11)

ψᵢ=arc tan{(yᵢ−yᵢ₋₁)/(xᵢ−xᵢ₋₁)} (12).

Here, (x₀, y₀), (x₁, y₁), . . . (xₙ, yₙ) denote the coordinates of the start and end points of each element line. (x₀, y₀), (xₙ, yₙ) denote the coordinates of the start and end points of the element. Furthermore, i and l denote the ith element line of the generator and the length of the element line, respectively. ψ and d denote an angle change amount and a direction for replacement, respectively. These symbols can be used to express parameters for the element line as (lᵢ, ψᵢ, dᵢ). Here, d can be defined as (0:A→B, 1:B→A).

(In the Relational Expressions Shown Below, n May be Replaced with i)

The grain element can be configured such that the start and end points of the grain element are located at (1, 0), that is, the length of the grain element is 1. In this case, the characteristics of each element line can be expressed by:

$$\begin{matrix}[ Formula 11 ] & \\ \begin{matrix}λ {L}_{i} = λ ( \begin{matrix}{I}_{i} & {I}_{i}^{′} )\end{matrix} \\ = ( \begin{matrix}λ {I}_{i} & λ {I}_{i}^{′} )\end{matrix} \\ = ( \begin{matrix}λ {l}_{xn}^{′} & λ {l}_{xn}^{′} \\ λ {l}_{yn} & λ {l}_{yn}^{′}\end{matrix} )\end{matrix} & Λ ( 13 )\end{matrix}$$

Here, {L′ᵢ} denotes the initial amount of the element line subjected to movement, rotation, enlargement, or reduction. In the formula, Iᵢ and I′ᵢ denote position vectors for the start and end points of the element line. In this case, since the initial length is 1, the rate of enlargement or elongation is given in view of λ determined by Formula (4).

For the burial, in the direction A→B, the position resulting from the enlargement or reduction can be given by:

$$\begin{matrix}λ {L}_{n} = λ ( \begin{matrix}{I}_{n} & {I}_{n}^{′} )\end{matrix} \\ = ( \begin{matrix}λ {I}_{n} & λ {I}_{n}^{′} )\end{matrix} \\ = ( \begin{matrix}λ {l}_{xn} & λ {l}_{xn}^{′} \\ λ {l}_{yn} & λ {l}_{yn}^{′}\end{matrix} ) .\end{matrix} \qquad [ Formula 12 ]$$

Then, the element line is rotated by φ. The amount λLₙ by which the element line has moved is multiplied by a rotating matrix.

$$( \begin{matrix}cos ϕ & - sin ϕ \\ sin ϕ & cos ϕ\end{matrix} ) ( \begin{matrix}λ {I}_{n} & λ {I}_{n}^{′} )\end{matrix} = ( \begin{matrix}cos ϕ & - sin ϕ \\ sin ϕ & cos ϕ\end{matrix} ) ( \begin{matrix}λ {l}_{xn} & λ {l}_{yn}^{′} \\ λ {l}_{xn}^{′} & λ {l}_{yn}^{′}\end{matrix} ) \\ = ( \begin{matrix}λ ( \begin{matrix}{l}_{xn} cos ϕ - \\ {l}_{yn} sin ϕ\end{matrix} ) & λ ( \begin{matrix}{l}_{xn}^{′} cos ϕ - \\ {l}_{yn}^{′} sin ϕ\end{matrix} ) \\ λ ( \begin{matrix}{l}_{xn} sin ϕ + \\ {l}_{yn} cos ϕ\end{matrix} ) & λ ( \begin{matrix}{l}_{xn}^{′} sin ϕ + \\ {l}_{yn}^{′} cos ϕ\end{matrix} )\end{matrix} ) \qquad [ Formula 13 ]$$

Finally, the position of an origin is translated to a point A.

$$\begin{matrix}{L}_{n}^{′} = ( \begin{matrix}λ ( {l}_{xn} cos ϕ - {l}_{yn} sin ϕ ) & λ ( {l}_{xn}^{′} cos ϕ - {l}_{yn}^{′} sin ϕ ) \\ λ ( {l}_{xn} sin ϕ + {l}_{yn} cos ϕ ) & λ ( {l}_{xn}^{′} sin ϕ + {l}_{yn}^{′} cos ϕ )\end{matrix} ) + ( \begin{matrix}{a}_{1} & {a}_{1} \\ {a}_{2} & {a}_{2}\end{matrix} ) \\ = ( \begin{matrix}λ ( {l}_{xn} cos ϕ - {l}_{yn} sin ϕ ) + {a}_{1} & λ ( {l}_{xn}^{′} cos ϕ - {l}_{yn}^{′} sin ϕ ) + {a}_{1} \\ λ ( {l}_{xn} sin ϕ + {l}_{yn} cos ϕ ) + {a}_{2} & λ ( {l}_{xn}^{′} sin ϕ + {l}_{yn}^{′} cos ϕ ) + {a}_{2}\end{matrix} )\end{matrix} \qquad Λ ( 14 )$$

For B→A, enlargement, reduction, and rotation are similarly expressed by:

$$( \begin{matrix}λ ( \begin{matrix}{l}_{xn} cos ( ϕ - \frac{π}{2} ) - \\ {l}_{yn} sin ( ϕ - \frac{π}{2} )\end{matrix} ) & λ ( \begin{matrix}{l}_{xn}^{′} cos ( ϕ - \frac{π}{2} ) - \\ {l}_{yn}^{′} sin ( ϕ - \frac{π}{2} )\end{matrix} ) \\ λ ( \begin{matrix}{l}_{xn} sin ( ϕ - \frac{π}{2} ) + \\ {l}_{yn} cos ( ϕ - \frac{π}{2} )\end{matrix} ) & λ ( \begin{matrix}{l}_{xn}^{′} sin ( ϕ - \frac{π}{2} ) + \\ {l}_{yn}^{′} cos ( ϕ - \frac{π}{2} )\end{matrix} )\end{matrix} ) . \qquad [ Formula 15 ]$$

Finally, the element line is moved so that a point B is located at the center.

$$\begin{matrix}[ Formula 16 ] & \\ \begin{matrix}{L}_{n}^{′} = ( \begin{matrix}λ ( \begin{matrix}{l}_{xn} cos ( ϕ - \frac{π}{2} ) - \\ {l}_{yn} sin ( ϕ - \frac{π}{2} )\end{matrix} ) & λ ( \begin{matrix}{l}_{xn}^{′} cos ( ϕ - \frac{π}{2} ) - \\ {l}_{yn}^{′} sin ( ϕ - \frac{π}{2} )\end{matrix} ) \\ λ ( \begin{matrix}{l}_{xn} sin ( ϕ - \frac{π}{2} ) + \\ {l}_{yn} cos ( ϕ - \frac{π}{2} )\end{matrix} ) & λ ( \begin{matrix}{l}_{xn}^{′} sin ( ϕ - \frac{π}{2} ) + \\ {l}_{yn}^{′} cos ( ϕ - \frac{π}{2} )\end{matrix} )\end{matrix} ) + ( \begin{matrix}{b}_{1} & {b}_{1} \\ {b}_{2} & {b}_{2}\end{matrix} ) \\ = ( \begin{matrix}λ ( \begin{matrix}{l}_{xn} cos ( ϕ - \frac{π}{2} ) - \\ {l}_{yn} sin ( ϕ - \frac{π}{2} )\end{matrix} ) + {b}_{1} & λ ( \begin{matrix}{l}_{xn}^{′} cos ( ϕ - \frac{π}{2} ) - \\ {l}_{yn}^{′} sin ( ϕ - \frac{π}{2} )\end{matrix} ) + {b}_{1} \\ λ ( \begin{matrix}{l}_{xn} sin ( ϕ - \frac{π}{2} ) + \\ {l}_{yn} cos ( ϕ - \frac{π}{2} )\end{matrix} ) + {b}_{2} & λ ( \begin{matrix}{l}_{xn}^{′} sin ( ϕ - \frac{π}{2} ) + \\ {l}_{yn}^{′} cos ( ϕ - \frac{π}{2} )\end{matrix} ) + {b}_{2}\end{matrix} )\end{matrix} & ( 15 )\end{matrix}$$

[Superimposition of Grains]

The actual examples of leather grains in FIG. 15 indicate that the leather grains can be simulated using the branch structure elements and that in the patterns, grains each composed of a group of points are superimposed on one another. That is, another grain pattern made up of the point groups is superimposed on the pattern of the branch structure. What grain structures form the resulting patterns when superimposed on one another remains to be seen. However, a new grain pattern is expected to be created by modifying the generator structure and applying a part or all of the technique according to the present invention to the modified generator structure. Then, a more natural grain pattern is expected to be created by superimposing the new grain pattern on the branch structure grain pattern.

[Utilization of the Grain Pattern for Die Processing]

Efforts have been made to increase the added values of a print product by producing dies with embossed shapes according to the grain pattern, and stamping the embossed shapes into a material such as resin coated or laid on the print product so as to form a non-in-sync pattern or an in-sync pattern in association with the print product. In recent years, demands for such print products have been increasing.

For the created grain pattern, information on the width of each element line can be associated with information on the depth of the element line to obtain three-dimensional information. Color information can also be added to the grain pattern. For the branch structure grain, a larger line width can be set for the part of a stem structure. Furthermore, the width can be increased based on information on a direction perpendicular to the screen. This film information can be utilized for die production based on the conventionally common photo etching scheme. Recently, a method based on laser irradiation scanning has been also available. On the other hand, this three-dimensional information can be converted into tool driving information that can be used directly for the die production. This enables a reduction in the time required to produce dies for the grain pattern and the delivery period for grain pattern formed product using the dies. If the three-dimensional information on the grain is used for a machine tool, the three-dimensional information can be transmitted to the machine tool as CAM (Computer Aided Manufacturing) information required to drive tools to create a die shape in a material to be machined, to allow a female die and a male die to be produced. In the photo etching process, the use of the female die is required to produce the male die to be laid on top of the print product. However, the machine tool allows the male die to be directly produced.

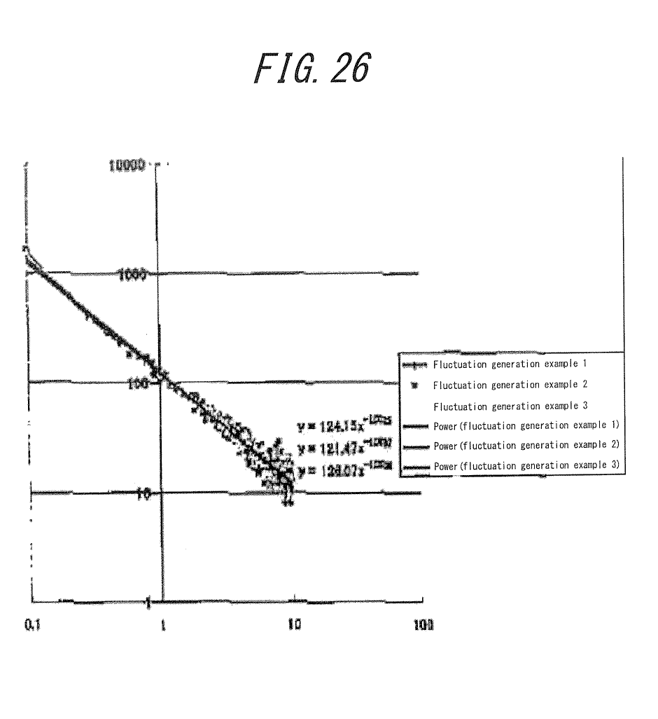

FIG. 26 shows that to verify the function of a “1/f fluctuation” generation module, “fluctuation random numbers” are determined for values in increments of 0.1 between 0.1 and 10, and the frequency for 5,000 outputs is determined three times to confirm the 1/f characteristic. A result of generally meeting a characteristic has been obtained from a characteristic determined by the least square method.

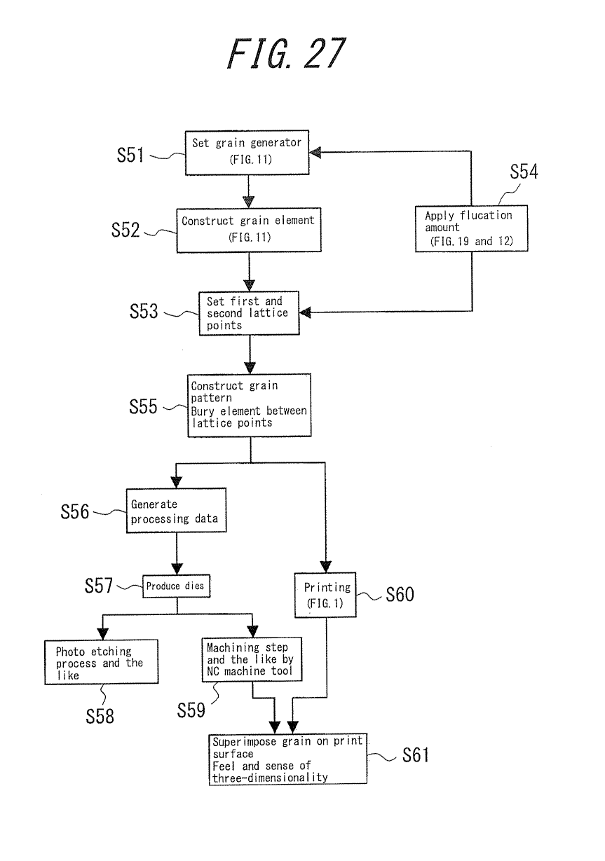

FIG. 27 shows a process of matching the three-dimensional surface shape produced by die processing with the product with the created pattern printed thereon; the process is included in the flow as a whole. For the wood grain and the like, the grain pattern is actually superimposed on the print pattern, which is a source pattern, so that the patterns are in sync with each other. However, there has been no example in which the above-described process is carried out on the grain pattern created in the computer. Thus, not only the grain pattern can be created but also products with an increased added value, that is, unprecedented designability, are expected to be able to be produced.

[Flow as a Whole]

FIG. 27 shows the flow, as a whole, of the above-described grain pattern creating system and the statuses of the functions provided during the process. Software provided in the computer makes up a module providing functions of, for example, setting the generator and the elements, setting the lattice points, generating and applying the fluctuation, and creating the grain pattern. This improves operability. Furthermore, an output for the die production can be converted into an input for the subsequent step via the interface based on the created data.

To be made natural, the grain pattern into which the generator is grown may be shaped such that terminal branches are thinner and have a shallow three-dimensional shape, whereas a part of the grain which corresponds to the stem is thick and has a deep three-dimensional shape.

With reference to FIGS. 9 and 10, description has been given of the generator and the creation based on the replacement using the generator, the creation of the corrugated generator with no branch, and the application of the diversity based on the replacement using the corrugated generator. FIG. 10 shows that the elements are created by expanding the replacements N′=1 to N′=3 from the stem to twigs. When the patterns with N′=2 and N′=3 are superimposed on the pattern with N′=1, the number of superimpositions decreases in the order of the stem, the branch, and the twig. That is, the number of superimpositions is larger in a portion with a smaller N′, that is, the portion replaced earlier. The element line can be drawn to have a width varying depending on the number of superimpositions. The width may be shown to be proportional to the number of superimpositions or the width rate may be shown to vary depending on the number rate of superimpositions.

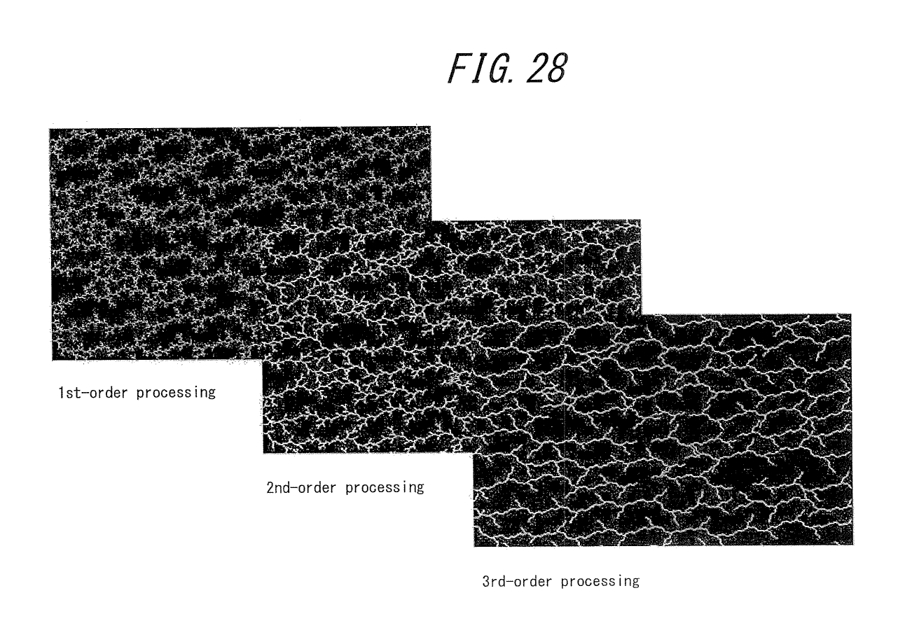

The grain pattern is typically generated on leather and has a three-dimensional recessed configuration. Furthermore, the dies may be produced based on the created grain pattern and utilized to create simulated leather. In this case, as a method for producing the dies based on the photo etching scheme, the following method using films is available. That is, as shown in FIG. 28, a grain created as a pattern is sequentially output on a film for each of 1st-order processing to 3rd-order processing so that the film can be used as an origin plate for the photo etching.

In this example, a grain with branch portions is created by subjecting a generator with no branch portion to replacement three times. In a part of the film for the 1st-order processing which corresponds to the third replacement, the number of superimpositions is smallest and the grain pattern is composed of the thinnest elements. The number of replacements is inversely proportional to the order of the processing because the etching processing starts with the thinnest grain pattern arrangement. As the processing proceeds to the 2nd-order and then to the 3rd-order, the element lines are drawn with thicker segments depending on the order. Since the pattern per se is composed of the patterns superimposed on one another depending on the order, the grain as a whole is expressed by the result of the superimpositions.

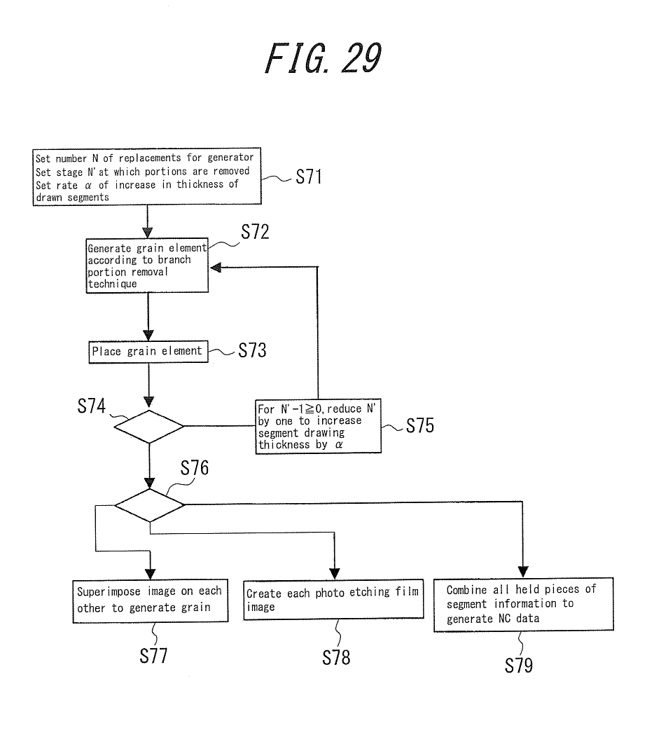

FIG. 29 shows a flow of creation of the grain element with the width varying. Here, the rate of increase in width resulting from superimpositions based on the setting of the number of replacements is defined as α. Applying the fluctuation corresponding to the coordinates to α also enables natural and diverse patterns to be provided.

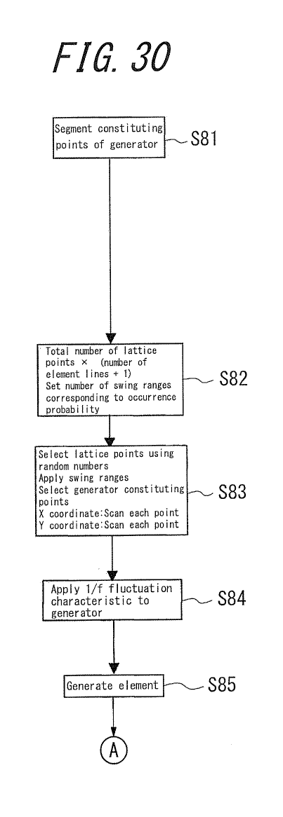

Furthermore, instead of or in addition to a flow of element generation shown at the right end of FIG. 13, a flow shown in FIG. 30 may be used to generate elements.

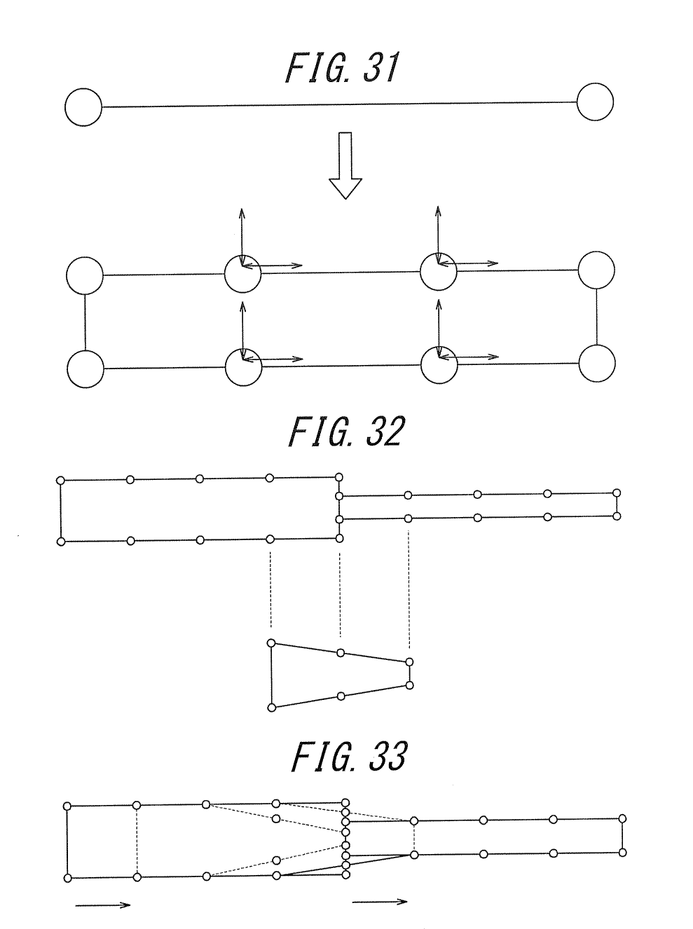

In the above-described embodiment, the generator, elements, and the like, which make up the fractal, are expressed as segments. However, in the present invention, to allow addition of an element that increases the line width and the width of which changes at a point corresponding to an intermediate portion of the segment, for example, the segment making up the branch structure may be defined as a rectangular region, with control points provided at appropriate points of the segment making up the outer contour of the rectangular region, as shown in FIG. 31. The control points are allowed to function as change points for a corrugated folded shape or change points for the length and/or width based on the application of the 1/f fluctuation so as to provide the segment with diversity and naturalness. Thus, the diversity and naturalness of the segment width can be significantly varied. A variation in height direction is based on a circular shape corresponding to the width. Control points are placed on the circular shape to change the shape of the segment.

If the segment is defined as shown in FIG. 31, the width of the segment changes rapidly at a connection portion. Thus, an appropriate measure needs to be taken to establish a smooth connection. As shown in FIG. 32, a possible measure assumes a segment expressed by a trapezoid with ends corresponding to control points arranged adjacent to each other across the connection portion between adjacent rectangles with different widths, assumes control points at least at the ends of the trapezoid and a longitudinally intermediate portion of the trapezoid corresponding to the original connection portion, and allow the control points to function as change points for the corrugated folded shape or change points for the length and/or width based on the application of the 1/f fluctuation so as to provide the segment with diversity and naturalness (a smoothing method based on the connection portion deforming segment).

As shown in FIG. 33, another measure for constructing the connection portion shifts the initial segment rightward so as to change the width of the segment based on the intervals between the control points at the end of the segment. To enable a smooth connection at the end of the initial segment, the control points are moved to the width of the trapezoidal segment to be connected to the end of the initial segment. The fluctuation is applied to the end to provide the segment with diversity and a change as described above. Thereafter, the segment is shifted as described above. Thus, in this example, connection to the left end of the segment with the right width thereof reduced can be established. Subsequently, the segments can be expanded as is the case with the method shown in FIGS. 31 and 32 (a connection portion smoothing method based on segment movement).

In FIGS. 31, 32, and 33, the segments are straight lines. However, the segments can be folded by applying the fluctuation to the segments.

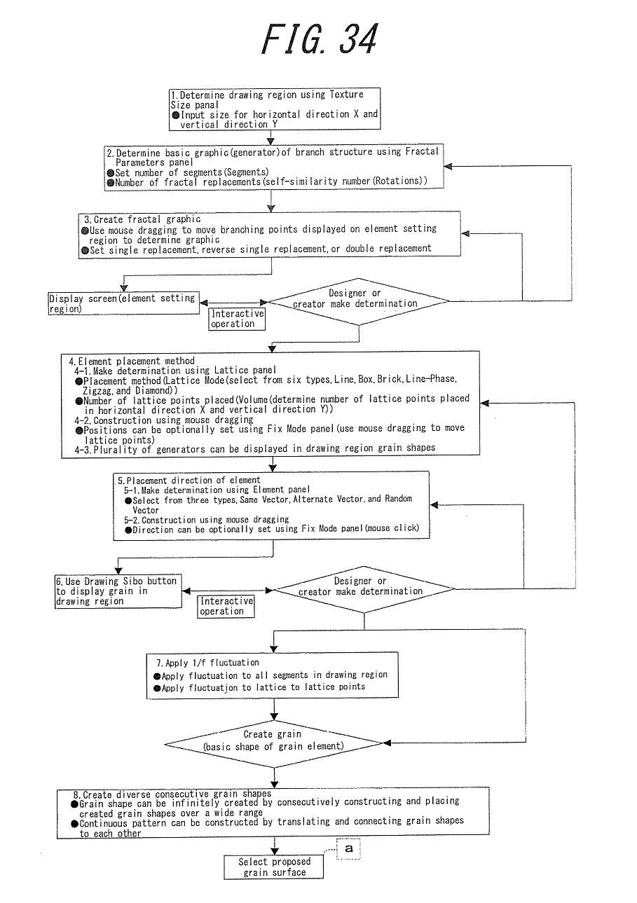

FIG. 34 is a flowchart of a program allowing the grain design to be created as described above through interactions with the computer. The program is characterized as described below.

### A. Interactive Operation

The generator is interactively constructed using a mouse and panel descriptions. Thereafter, the elements are constructed to create the grain based on the applied contents.

### B. Construction of Diverse Grains

Various grains can be created on the screen by a process starting with the interactive operations described in A.

The present system is characterized in that by varying parameters that most significantly affect the grain shape to display the grain shape generated in response to the variation in any of the parameters, in real time, the designer, the creator, and the like can repeatedly check and modify the grain shape to create an improved design; the parameters include the “definition of the generator shape”, the “number of replacements for the generator”, an “arrangement rule for the lattice points”, a “rule for arrangement of the grain elements at the lattice pints”, “parameters for a fluctuation function”, and a “misalignment prevention parameter for a continuous pattern”.

The designer and the creator can voluntarily set the “definition of the generator shape”, the “number of replacements for the generator”, the “arrangement rule for the lattice points”, the “rule for arrangement of the grain elements at the lattice pints”, the “parameters for a fluctuation function”, and the “misalignment prevention parameter for a continuous pattern”, to interactively construct the design on the computer system.

The generator shape can be set to be composed of one or more parts. Thus, by carrying out a process of making the grain shape continuous, the grain shape can be prevented from appearing regular (unnatural) to users, enabling a more natural design to be created.

The system is characterized by compositely using the “fractal” and “1/f fluctuation”, which are present in nature, to generate diverse grain shapes and to enable the impression of the shape to be controlled. Thus, various designs ranging from a geometrical design to a natural design can be created.

[General Description of the System]

### (Basic Method for Grain Design)

Generate grain elements based on the method of generating a geometrical fractal.

Combine the grain elements to construct a grain shape.

Apply the “1/f fluctuation” to the combined positions of the grain elements to make the grain elements natural.

Specify a numerical value for the level of the “1/f fluctuation” to enable quantitative control of the impression.

The basic method will be described below with reference to FIG. 34. In the figure, numbers enclosed by circles are represented, in the specification, as numbers enclosed by parentheses because of restrictions on text input.

### [Method of Generating a Grain Shape]

### (1) Setting a Drawing Size

Input a size in an X direction and a Y direction→determine an element setting region using a grain size panel.

### (2) Forming a Geometrical Fractal

2•1. A generator (a geometrical shape composed of segments) is freely defined, and the segments making up the generator are replaced with the shape of the generator per se to form such a geometrical fractal as shown in FIG. 6.
2-2. The number N of replacements with the generator per se is used as a parameter for controlling the “complicatedness” of the grain shape. (N=1 indicates similarity. The complicatedness of the shape increases consistently with N.)

### (3) Generating a Grain Shape (Introducing Fractal Graphic Grain Elements)

3•1. Since the shape of the generator and the number of replacements can be freely varied on the screen, the designer and the creator can determine the final graphic shape on the screen in real time.
3•2. A fold point connecting segments of a branch structure together is freely moved by dragging the mouse. Thus, a basic element graphic is obtained below the branch structure in real time.
(4) Arrangement rule for the grain element
4•1. In order to generate the “directionality” found in the pattern of artificial leather, a Lattice MODE in a Lattice panel is used to select lattice points from the examples in FIG. 14 (lines, bricks, and diamonds) plus a box, a line-phase, and a zigzag to consecutively or discontinuously arrange grain elements to obtain a basic grain shape (identical grain elements are formed and arranged first at equal intervals). Furthermore, volume-X/Y in the Lattice panel is used to determine the number of elements to be arranged, to set the number of lattice points in the X and Y directions.
4•2. By appropriately checking a Fix Mode panel, the designer and the creator can optionally change the positions of the lattice points, voluntarily using mouse dragging.
4•3. By defining, creating, and setting a plurality of generators on the screen, the description of the element between the lattice points can be changed.

(5) Element Arrangement Direction

5•1. Determine the direction on an Element panel
Same Vector Maintain the fractal graphic in the same direction.
Alternate Vector Alternately reverse the placement direction with respect to the direction in which the elements are consecutively arranged.
Random Vector The computer automatically determines the direction of each element at a random probability.
5-2. By appropriately checking the Fix MODE panel, the direction of the element can be optionally changed via mouse clicks. Since the “arrangement rule for the lattice points” and the “rule for fitting of the grain element between the lattice points” can be freely set using a mouse pointer (free movement of the lattice points), the designer can voluntarily interactively generate diverse basic shapes.

### (6) Using a DRAW Sibo Button to Display a Grain in a Drawing Region

The DRAW Sibo button is depressed to display a grain in the drawing region (the element setting region in (1)). At this time, the designer and the creator may optionally change any of the various parameters to reflect the change in the grain in the drawing region in real time. Thus, several persons including the designer and the creator can freely reflect the change in the grain on the screen while checking the grain.

### (7) Applying the 1/f Fluctuation

The “1/f fluctuation” property is automatically applied to all the segments in the drawing region to apply a natural impression to the basic grain shape, formed in (6) and appearing regular.

The parameters are set: “NOISE Check” is checked. →“X Way (X direction), Y way (Y direction), and Width (Line) (segment width direction)” is used to set the parameters with reference to visualized lattice-like squares displayed in the drawing region (element setting region).

The parameters for the “1/f fluctuation” are the x and y coordinate positions of the opposite ends of each constituent segment of the grain element (movement of is the x and y coordinate positions at the opposite ends of the segment), the width of the segment (the amount of change in width), and the depth of the segment→the amount of change in depth. Formulae (16) and (17) are used to set the parameters.

$$\begin{matrix}[ Formula 17 ] & \\ Z ( x , y ) = \sum \frac{Sin ( {n}^{i - 1} f ( x , y , i ) ) + Sin ( {n}^{i - 1} f ( y , x , i ) )}{{n}^{ɛ ( i - 1 )}} & ( 16 )\end{matrix}$$

### [Formula 18]

f(x,y,i)=Sin(X+a Sin(βy)+(i−1)γ) (17)

The value of a parameter ε is optionally varied around 1 to enable the impression of the grain shape to be controlled (the level of the fluctuation is “1/f” when the parameter ε=1, and the grain shape gives a monotonous impression when ε>1 and a stimulating impression when 1>ε>0).

The x and y coordinate positions at the opposite ends of the constituent segment of the grain element=“FIELD Noise On” are checked.

Width of the segment→“Field Noise On” and “MODE Line to Box” are checked, and “FIELD Width Noise On” is checked.

### (8) Creating Diverse Continuous Grain Shapes

If a grain shape covering a large area is to be generated, a technique is adopted which consecutively arranges the grain shapes formed in (6) or (7) to construct the entire grain shape.

8•1. Process of making the grain shape continuous in constructing the basic shapes

The introduced concept of the lattice points is utilized to allow arrangement of grain elements to be newly consecutively arranged on the left, right, top, and bottom of the area of the basic shape with the lattice points consecutively arranged according to the same rule. The generated shape is defined as a unit shape for a continuous pattern. This hinders the grain from giving the impression that the grain is composed of repeatedly regularly arranged identical patterns. Thus, a more natural grain shape and an object that can be put to practical use can be selected.

### Operation Method:

Grain shapes are consecutively connected together in a vertical direction and a lateral direction over a wide range→“Seamless” in a Render Grain panel is checked.

The lateral connection position is translated by a distance corresponding to the number of vertical lattice points→A numerical value is input to Slip.

### 8•2. Process of Applying the Fluctuation to Make the Grain Shape Continuous

To prevent the grain from being discontinuous at the connection portion as a result of the simple application of the “1/f fluctuation” to each unit shape, a condition is set which allows Formula (16) to provide a periodic function that uses the lateral and vertical widths of the unit shape in the x and y directions as periods, so that the amounts of change at the boundaries between the connected unit shapes, determined by Formula (16), are equal.

8•3. Advanced process of making the grain shape continuous

To prevent the shape of identical patterns repeatedly arranged in the lateral direction from appearing regular (unnatural) to users, the pattern can be made continuous by slightly translating unit shapes with vertex positions that do not align with one another in the vertical or lateral direction.

This process prevents the grain from appearing unnatural even with the freely arranged lattice points or the use of a plurality of generators.

According to the present invention, the created grain pattern is evaluated as described below.

### 1. Selecting the Designability of the Pattern

The method of creating the grain in the computer applies the probabilistic characteristic to the variable elements, thus enabling an almost infinite number of patterns to be created. As the probabilistic characteristic, the 1/f fluctuation, found in the results of analysis of phenomena in nature, is introduced into the method. The created grain can thus exhibit this characteristic. However, whether or not to be able to put the pattern to practical use is expected to rely on the printing technique or the product designer's experience in pattern development and feeling.

On the other hand, basically, patterns in nature have been directly utilized as grains. In this case, selection of a particular pattern is based on whether or not the designer or any other staff member determines the pattern to be “beautiful”. However, how the pattern has been determined to be “beautiful” has not been logically explained.

2. Application of Two-dimensional Fourier Transformation

As the above-described evaluation technique, a technique based on two-dimensional Fourier transformation will be described below. In connection with the above-described 1/f fluctuation characteristic, for example, for a wood grain used as an alternative building material, data on the shading of the wood grain in a direction orthogonal to the one in which the wood grain flows is acquired. A series of data thus acquired are subjected to Fourier transformation to obtain a power spectrum. Then, whether or not the power spectrum exhibits the 1/fluctuation characteristic is determined. Whether or not the created grain exhibits the 1/f fluctuation characteristic is also based on a similar evaluation.

The conventional method of evaluating the characteristic in nature and the conventional determination of whether or not the creation result exhibits the characteristic rely on the evaluation for one direction in which the characteristic may be found, as described above. This is because in the current computer environment in which the power spectrum is acquired by the Fourier transformation in the one direction, results are sufficient which are provided by the technique of allowing relatively easy determination of the property, of the pattern, of exhibiting irregularity such as a wood grain or a grain. However, in both grain and wood grain, the characteristic pattern expands two-dimensionally. Thus, two-dimensionally evaluating the characteristic of the pattern enables the utilization of a technique for introducing generality into the evaluation of designability, which allows the selection of “beauty”, which is more or less sensitive.

3. Applied Example of the Two-Dimensional Fourier Transformation Based on Comparison with the Pattern

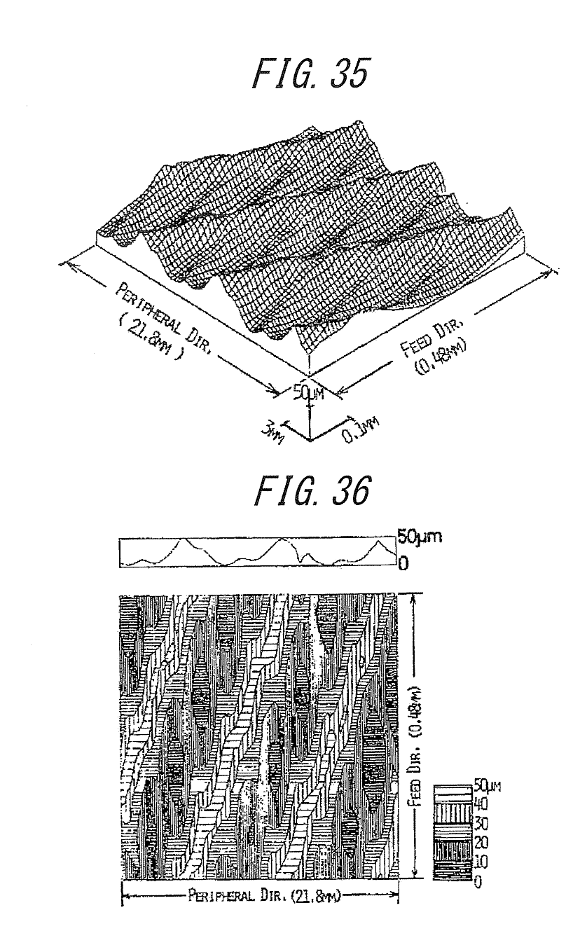

FIG. 35 shows an example of a two-dimensionally expanded surface pattern that is not a wood grain but is similar to one. A method of subjecting the surface pattern to the two-dimensional Fourier transformation will be described below to understand the above-described evaluation method based on the two-dimensional Fourier transformation. The surface in FIG. 35 has recesses and projections and thus forms a three-dimensional shape. Using contours allows the shape to be displayed as shown in FIG. 36. In FIG. 35, the height, showing the shape of the surface, is expressed as a functional value for a two-dimensional position. However, for a pattern such as a grain or a wood grain, instead of the height and shape, the shading can be used for the display.

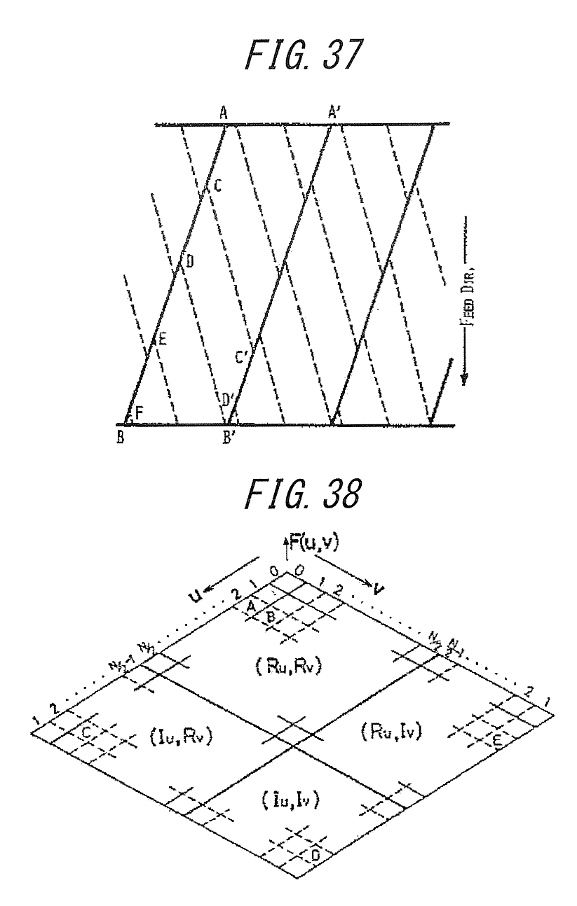

FIG. 37 shows abstracted characteristic lines read from the shape in FIG. 36. The characteristic lines are periodic and different from the surface pattern of a grain or a wood grain, which has irregularity typified by the 1/f fluctuation. However, the lines are an illustration of the use of the two-dimensional Fourier transformation for the evaluation.

As in the case of the analysis of the 1/f fluctuation, the Fourier analysis is commonly used particularly to determine one-dimensional characteristics and is utilized in many applications. However, almost no attempt has been made to expand and utilize the Fourier analysis to determine the two-dimensional characteristics of the object. One reason is expected to be that even if the object is two-dimensionally expanded, in many cases, the characteristics of the object can be determined simply by determining the one-dimensional characteristics thereof in each axial direction, as is apparent from characteristic lines in FIG. 38.

4. Describing Relational Expressions for the Two-Dimensional Fourier Transformation

However, if patterns including grain patterns are created in the computer, a Fourier coefficient spectrum and a Fourier (power) spectrum can be utilized as indices for evaluating, for example, differences between the characteristics of such a pattern selected for practical use and the conventional characteristics, the common characteristics of actually supplied objects, and the characteristics with which the created pattern is to be provided. A Fourier transformation F(u,v) of a function f(x,y) of two variables x and y is expressed by:

### [Formula 19]

F(u,v)=∫₋28^{∞}∫₋28^{∞}f(x,y)×exp[−j2π(ux+vy)]dxdyΛΛΛΛΛ(1)

Furthermore, an inverse Fourier transformation of the function f(x,y) is expressed by:

### [Formula 20]

f(x,y)=∫₋28^{∞}∫₋28^{∞}F(u,v)×exp[j2π(ux+vy)]dudvΛΛΛΛΛ(2)

where j denotes a complex unit. When a real part and an imaginary part of F(u,v) are defined as R(u,v) and I(u,v), respectively, an energy (power) spectrum P(u,v) and a Fourier spectrum Q(u,v) are expressed by the following respective formulae.

### [Formula 21]

P(u,v)=R²(u,v)+I²(u,v)ΛΛΛΛΛ (3)

Q(u,v)=\sqrt{P(u,v)}ΛΛΛΛΛΛΛΛ (4)

The Fourier coefficient on which Formula (1) in [0105] has been executed is expressed by a region shown in FIG. 38 and including the real and imaginary parts for the two variables u and v. Here, N denotes the number of data for one variable and means the number of waves during an interval in which the data has been acquired. When the characteristic lines shown in FIG. 37 are set to be an object, the number of waves contained in the characteristic lines is analyzed and displayed.

5. Actual Examples in Which the Relational Expressions are Applied

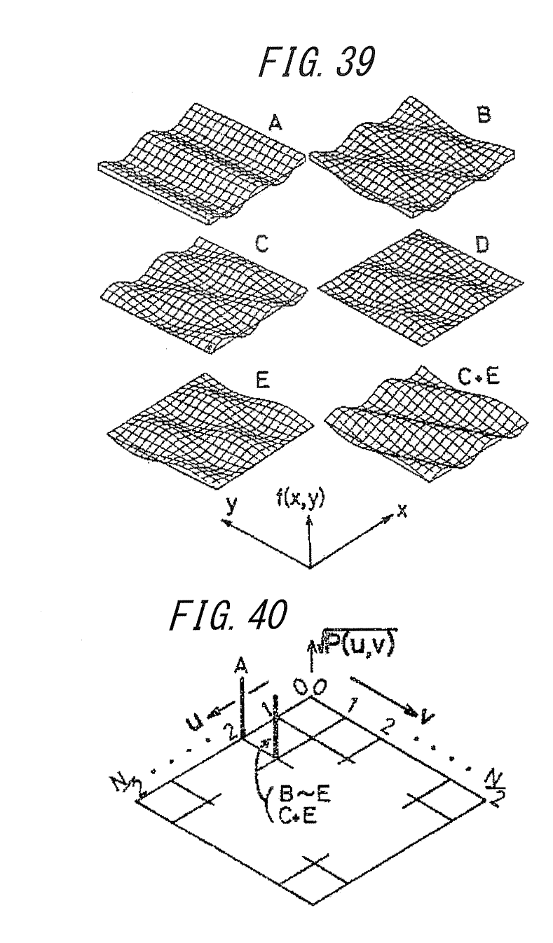

When the power spectrum is based on Formula (3) in [0107], the use of the complex unit is avoided to conceal a phase relationship for the presence of components. However, when a different expression is used to make the phase relationship visible, a completely different shape is described even with the same wave number component. That is, if components are assumed to be present in A to E in FIG. 38, then as shown in FIG. 40, the components in the same region except for A, that is, the components in B to E, are contained in the same expression. However, an inverse transformation of the expression in FIG. 4 results in a completely different shape as shown in FIG. 39. In other words, in the power spectrum, the shape shown in FIG. 39 is evaluated to be as shown in FIG. 40. Although this offers one index, the expression in FIG. 38 allows the characteristics of FIG. 39 to be preserved.

The application of the two-dimensional analysis to a grain or a wood grain fails to clarify many contents otherwise made clear by the analysis shown in FIG. 38 or the like. Thus, the application of the technique of the two-dimensional analysis is all the more potential.

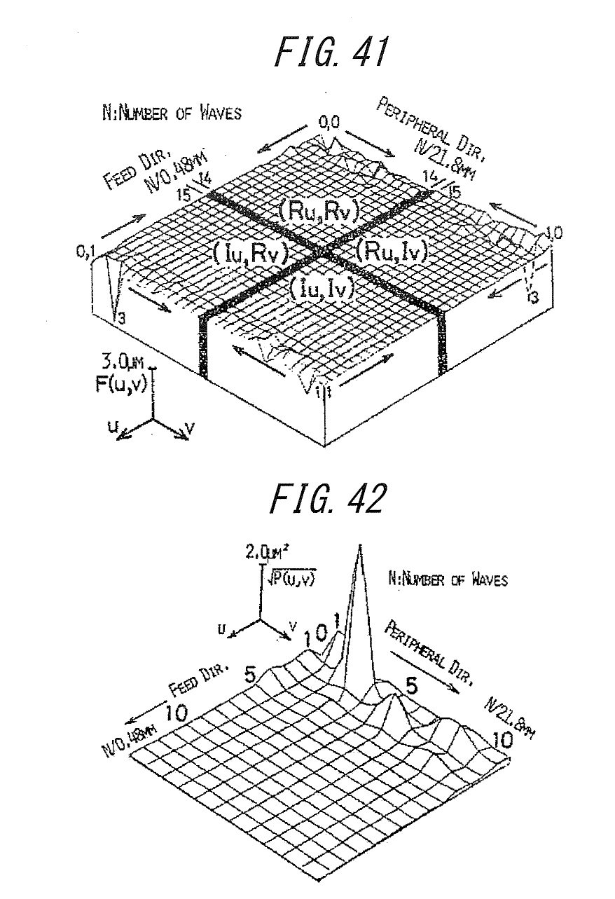

FIG. 41 shows a Fourier coefficient spectrum obtained from the surface pattern in FIG. 35. FIG. 42 shows a Fourier power spectrum obtained based on the Fourier coefficient spectrum. FIG. 41 corresponds to FIG. 38 and thus shows a phase characteristic. However, FIG. 42 corresponds to FIG. 40 and shows only the presence of frequency components.

The characteristics of grains already put to practical use can be determined by applying the present method to the grains. Furthermore, any of the grains created in the computer can be selected for practical use by applying the present method to the grains to assist in determining the “beauty” of the designs of the grains.

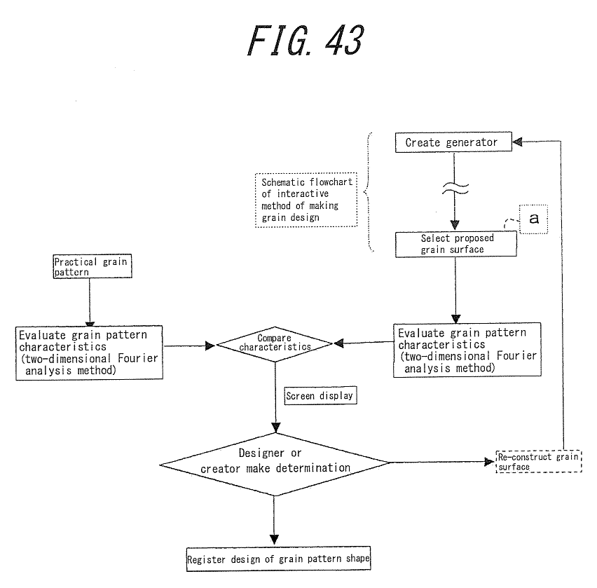

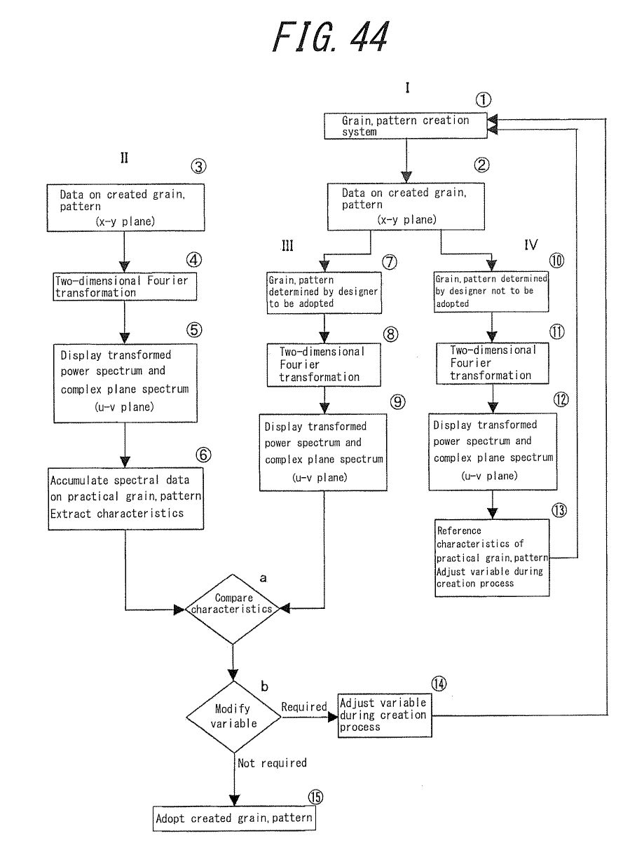

FIG. 43 is a flowchart of a process of extracting the characteristics of a practical pattern using the two-dimensional Fourier transformation and comparing the characteristics with the results of similar analysis of created patterns to evaluate and select from the created patterns. FIG. 44 is a flowchart of a process of determining whether or not to adopt a created grain pattern, based on extraction of the characteristics of a practical grain pattern using the two-dimensional Fourier analysis and on variable adjustment.

In examples of the present invention described below, analysis is performed on practical sample patterns for a wood grain, a geometrical pattern, a hairline, a leather grain, a cloth grain, a marble grain, a pearskin finish, and the like. The sample patterns include colors. However, at present, the colors are not evaluated, and the patterns are expressed at a single gray scale and analyzed. A technique of evaluating the patterns also in terms of the colors is a future challenge.

Furthermore, an emboss pattern is added to each of the original patterns to improve designability in corporation with the original pattern. This is also not taken into account in the evaluation. That is, the pattern is simply analyzed with the relationship between the pattern and each of the color and embossing not taken into account.

The analysis described below uses a power spectrum picture (PSP) instead of the Fourier coefficient spectrum. The power spectrum picture is obtained by using a two-dimensional frequency parameter to distribute a power spectrum as luminance (intensity) and showing the resulting three-dimensional information as one image. The power spectrum picture can be easily used for evaluation but has the disadvantage of being unable to perform the inverse transformation.

Patterns failing to be adopted as practical samples are unknown, with no record of analysis or comparison of these patterns saved. Thus, the characteristics of two-dimensional Fourier coefficient spectra obtained from the practical sample patterns may not perfectly be appropriate. However, at least what the characteristics of the practical sample patterns are like can be determined. Based on this, the characteristics can be described.

### [Evaluation Based on Information Entropy]

Some documents insist that besides the Fourier analysis, information entropy may used to evaluate beautiful expressions. Information entropy H is expressed using:

$$H = - {\sum }_{i = 1}^{N} {p}_{i} log {p}_{i} \qquad Λ ( 22 )$$

and an information occurrence probability pᵢ. Here, pᵢ denotes the occurrence probability of each color. When the number of pixels in the vertical and lateral directions of an image are defined as L and W, respectively, N=L×W.

In the description below, image information is converted into a gray scale. When the occurrence probability is determined using a scale of 0 to 255, this conversion is called fine division. When the levels 0 to 255 are divided into 10 levels, this division is called coarse division. Table 3 shows the results of the coarse division.

In either case, the relative relationship between the results exhibits the same tendency. The numerical value increases if the color varies significantly, with various colors appearing. In the case of a grain, the tendency is such that the value increases as decreasing width of the pattern and increases consistently with the area of a cloud and the luminance.

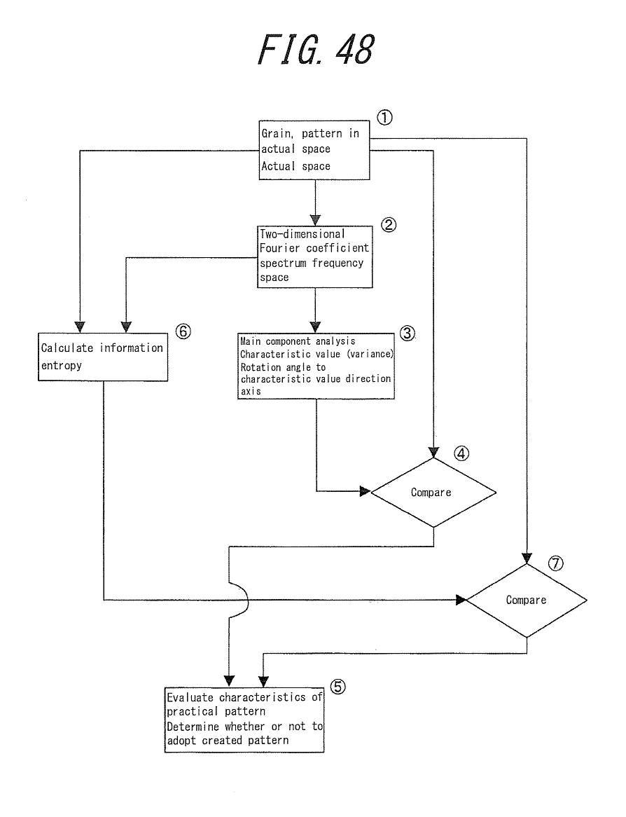

FIG. 48 is a flowchart showing that the characteristics of a pattern in an actual space can be described based on the results of analysis of main components based on the results of the Fourier analysis or by calculating the entropy from the grain, the pattern, or the Fourier coefficient spectrum. The patterns put to practical use have not been sufficiently verified. Furthermore, no method is available which enables determination of whether or not the pattern can be put to practical use based on the characteristics resulting from the analysis. The verification and such a method are future challenges. The present technique, which is at an analysis level, is used to offer an index for sensitivity, with the expectation that the technique will be developed to a comprehensive level.

As described above, although patterns can be checked for a certain characteristic, it is difficult, at present, to use the resulting numerical value to check for a characteristic that allows determination of whether or not the pattern is acceptable. However, efforts need to be made to enable detailed analysis and evaluation of association with quantification and main component analysis of various design patterns put to practical use.

2. Describing the Characteristics

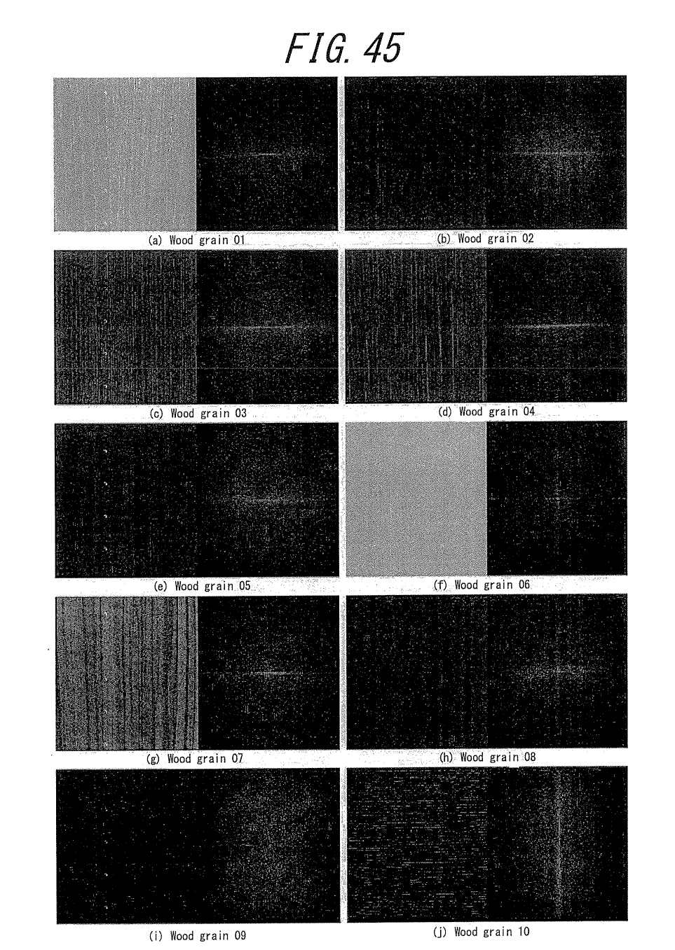

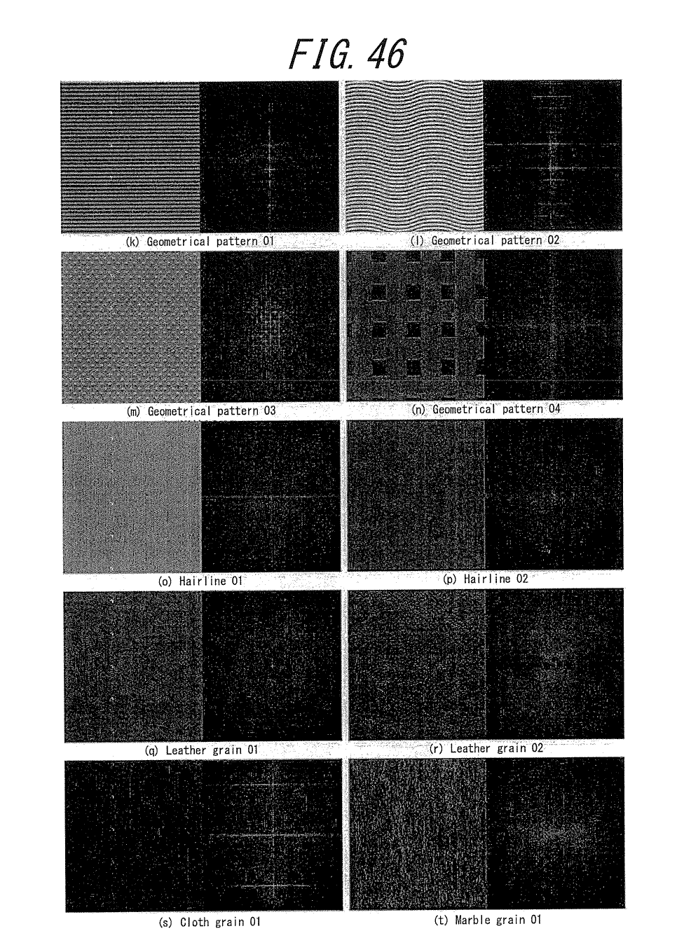

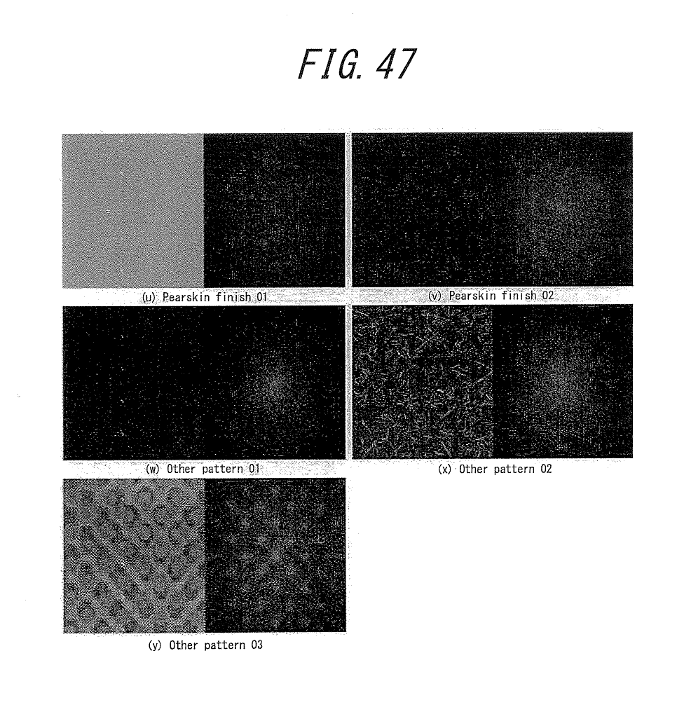

FIGS. 45 to 47 are PSPs of pattern samples that are to be put to practical use. The figures show the results of analysis of objects that are to be put to practical use; the results can be considered to be closely associated with practicality.

2.1 Wood Grain

(a) to (h) show wood grains running in the vertical direction. (j) shows a wood grain running in the lateral direction. (i) shows a grain of a root portion which has various nodal patterns. The root grain is an example of a pattern which is different from other, what is called wood grains.

(a) to (h) are spectra characterized by the spread of emission lines extending along a horizontal axis and the spread of a cloud around the periphery to of the emission lines. The color and the embossing are not taken into account. Thus, the effects of the color and embossing on practicality remain unknown. However, the spectra show the characteristics of the wood grains with at least the practicality taken into account.

At present, the wood grain cannot be checked for all the characteristics. However, the characteristics successfully analyzed according to the present invention can be described in brief as follows.

(1) The spectra are expressed by monotonous emission lines extending along the horizontal axis ((d), (f), and (g)).
(2) The spectra are based on emission lines extending along the horizontal axis and showing spread in a region of high frequency components ((a), (c), (e), (h), and (j)).

(3) The spectra show a cloud spreading around the origin, though the shading or the manner of the spread varies among the spectra ((b), (c), (e), (g), and (j)).

(4) A unique spectrum is observed in which the spread of a cloud contains an oblique pattern (i).

In the wood grain, a main component of force acts mostly in a direction perpendicular to the flow of the wood grain. The spectrum in (i) exhibits no characteristic corresponding to the flow. Thus, the direction of the main component of force is expected to be changed by the intended pattern. The primary result is the direction of the vertical axis, which corresponds to the spread of the cloud.

The entropy decreases consistently with the clarity of the wood grain. The entropy is high when the image is clear and emission lines extending along the axis are intense and spread, with the cloud also spreading ((c) and (j)), or when the wood grain is coarse (g), or when the nodes are emphasized and the cloud spreads (i).

For (f), (h), and (i), described above, the original image is difficult to see. Thus, aside from the relationship with the Fourier coefficient spectrum resulting from the two-dimensional Fourier transformation, images processed so as to be easy to see are separately shown. Spectrum diagrams have been obtained using the processed image data. However, some of the spectrum diagrams are also difficult to see. Thus, in the description below, the initially obtained spectrum diagrams are focused on and used to check the original images that are difficult to see.

As a result, (i) clearly shows that the pattern is configured based on the characteristics of the nodes in the root. In this case, the association with the form of the spectrum is easy to understand.

2.2 Geometrical Pattern

For the patterns in (k) and (l), the spectrum is characterized in that periodic components are superimposed on one another. For (k), emission lines extend along the vertical axis in association with a striped pattern. The spectrum is also characterized by bright points located at positions corresponding to periodicity. A characteristic cloudy shape extending along the horizontal axis indicates the presence of a certain type of striped pattern that is irregular, though no vertical stripe is found in the original image.

For (l), the spectrum is characterized by emission lines extending along the vertical axis and bright points located at points corresponding to periodicity. Furthermore, the presence of a periodic component is characterized by two emission lines extending from the corresponding frequency components along the vertical axis.

For (m), the spectrum is characterized in that three bright points are visible on the vertical axis, including a bright point on the vertical axis corresponding to a second frequency, whereas two bright points are visible on the horizontal axis because no bright point corresponding to the second frequency is present on the horizontal axis. In the original image, the point arrangement in the horizontal direction is similar to that in vertical directions; only two bright points are visible in the horizontal direction, though three bright points are expected to be visible. This is expected to be because the point arrangements in the original image are such that an asymmetric image the lower half of which is shaded by lighting from above is formed on the horizontal axis, whereas an image showing the object as it is formed in the lateral direction.

For (n), the spectrum is characterized by orthogonal emission lines spreading along the coordinate axes. The original image is a pattern of regularly arranged rectangles. However, the rectangles are not consecutive in the direction of the horizontal or vertical axis, resulting in the emission lines extending along the coordinate axes but showing spread.

For (k), (l), and (m), the results of the main component of force analysis match the characteristics of the spectrum. The results for (n) also appear to match the characteristics of the spectrum; the form of the spectrum appears to indicate that the required angle does not involve rotation of the axis. However, the primary direction corresponds to rotation of the axis through 26°. This is assumed to be because the direction is not determined by the emission lines extending along the axial direction but by a slight bias of the spread of the cloud in the vicinity of the center.

The entropy exhibits the largest value for (k) and similar values in the other cases. The exact reason for this remains to be seen, but one possible reason is that the stripe is thin and the pattern is dense.

2.3 Hairline

In both (o) and (p), lines extend in the vertical direction and is expressed as emission lines extending along the horizontal axis. The irregularity of arrangement of the lines is expressed as the spread of the emission lines extending along the horizontal axis. The irregularities of a ground plane in the directions of the horizontal and vertical axes are expressed as the spread of the cloud in the vicinity of the origin.

The main component of force analysis indicates that the primary direction is determined depending on the emission lines corresponding to the flow direction and is the same as the direction of the original axis.

The entropy of the hairline is less characteristic than those of the other patterns, and is expected to have a small value.

### 2.4 Leather Grain

In the spectrum in (r), clear dark patterns divide the characteristic cloud in the flow direction. The spread of the cloud exhibits a well-defined fan shape. Furthermore, the spectrum shape in (q) is characterized in that the central portion of the cloud is dark and the spread of the cloud appears circular.

The main component of force analysis indicates that for (q), the direction is not clear and is expected to be the same as that of the original axis. Furthermore, for (r), the spread of the cloud indicates rotation of the primary axis through 90°.

The value of the entropy is small for (q) and is equivalent to the larger entropy value of the wood grain for (r). This difference is indicated by the spread of the cloud.

For (q), the characteristics of the spectrum have been eliminated by processing the original image so as to make the details of the image easy to see. Whether or not the data collection method used is appropriate remains to be seen. However, the initially obtained spectrum shape is determined to be the currently appropriate result and used for comparison.

2.5 Cloth Grain

The cloth grain is always characterized by emission lines on the horizontal axis. However, previous spectra are characterized by an emission line for a basic frequency which is parallel to the vertical axis and in that a pronounced spread of a cloud is observed in a region enclosed by a rectangle defined by the basic frequencies on the vertical and horizontal axes. In contrast, in the present spectrum, pronounced emission lines indicating the presence of characteristic frequencies on the vertical axis are observed in the direction of the horizontal axis. The spectrum characteristic depends on the detailed structure of the cloth grain. The characteristic that is not so noticeable in the pattern is easily observable in the spectrum.

The results of the main component of force analysis are as expected from the form of the spectrum. On the other hand, the value of the entropy indicates the largest region. The form of the spectrum indicates that these results are associated with a striped pattern in both the vertical and horizontal directions, which is characteristic of the cloth grain.

2.6 Marble Grain

In FIG. 9, for (a), the characteristics of a concrete surface are determined. However, the pattern in the original image is completely different. The spectrum is characterized by the spread of a cloud. For the present object, the pattern in the original image appears to flow in the vertical direction. This corresponds to the spread of the cloud with a break slightly inclined leftward with respect to the direction of the vertical axis. On the other hand, the spread is slightly rounded in a lower left corner and an upper right corner.

Although not limited to the marble grain, the spread varies depending on the characteristics of the pattern. However, the characteristics of the marble grain, like those of the grain and pearskin finish, are expected to be indicated by the spread of the cloud. Thus, for patterns to be put to practical use, the significance of evaluation can be clarified by continuing to accumulate data.

The main component of force analysis indicates that the direction is the same as that of the axis as expected from the spread of the cloud. The numerical value of the entropy also indicates a large region. These results are expected to relate to insignificant characteristic variations of the object and a significant variation of the marble grain.

Pearskin Finish

In the pearskin finishes shown in (u) and (v), the spectrum is shown as a spread of a cloud. In the present example, the original images are difficult to see. Thus, the results of measurement examples need to be continuously accumulated. However, in the present example, the pattern in (u) is finer and difficult to express as a shade image. On the other hand, the pattern in (v) is rough. For (v), the spread of the cloud in a target region is wider and more uniform than that in the other examples.

The results of the main component of force analysis are based on the relational expressions. The direction of the angle is not visually clear. In (u), the cloud is not shiny. However, a variance value for (u) is equivalent to that for (v), in which bright points exhibit a high density. Thus, these numerical values are helpful for determining the characteristics.

The value of the entropy is small for (u) and large for (v). This is expected to be because in (u), the original image is fine and light and in (v), the spectrum shows a cloud with very bright points and a large spread.

The original image in (v) is difficult to see. The original image with shading modified so as to be easy to see is clearer.

2.8 Other Patterns

(w) shows abstractive decorative patterns arranged all over the surface. (x) shows a pattern in which decorations such as yarn waste or fine masses of Japanese paper which are elongate but have an irregular length and an irregular width are evenly and irregularly laid all over the surface.

Both spectra spread circularly and exhibit a wide and bright central portion. In (x), emission lines spread radially, and this characteristic is extraordinary.

(y) shows a pattern that can be classified as a geometrical pattern; the spectrum has a corresponding form. This sample is characterized as follows. A cylindrical image is seen in a slightly thick transparent resin. The cylindrical image varies depending on a visual angle. The cylindrical image can function as a screen or the like by preventing an object located behind the screen from being viewed while maintaining decorativeness. This sample is selected because of the characteristic manner in which the sample is viewed. However, the whole characteristics of the image cannot be determined. The original image is acquired within the operational range of a scanner, and the spectrum is obtained from the image.

When the shading of the original image in (w) is modified so as to make the image easy to see, the resulting image shows a clear decorative pattern. The spectrum of the image shows characteristics that are not shown by the initial transformation. Although the cloud spreads uniformly, the analysis indicates rotation of the primary axis through 21°. For (y), the variance value indicates the largest region.

The value of the entropy is medium for (w) and (x) and largest for (y).

Information entropy (rough division)

(a) Wood grain 01 1.51
(b) Wood grain 02 1.98
(c) Wood grain 03 2.14
(d) Wood grain 04 1.84
(e) Wood grain 05 1.9
(f) Wood grain 06 0.0355
(g) Wood grain 07 2.07
(h) Wood grain 08 1.86
(i) Wood grain 09 2.04
(j) Wood grain 10 2.06
(k) Geometrical pattern 01 2.27
(l) Geometrical pattern 02 1.86
(m) Geometrical pattern 03 1.81
(n) Geometrical pattern 04 1.88

### (o) Hairline 01 1.2

### (p) Hairline 02 1.13

(q) Leather grain 01 1.44
(r) Leather grain 02 2.02
(s) Cloth grain 01 2.26
(t) Marble grain 01 2.06
(u) Pearskin finish 01 1.3
(v) Pearskin finish 02 2
(w) Other pattern 01 1.78
(x) Other pattern 02 1.7
(y) Other pattern 03 2.47

### 3. SUMMARY

The typical practical sample patterns have been subjected to the two-dimensional Fourier transformation, PSP, the analysis of the main component of force for the Fourier coefficient spectrum resulting from the transformation, and the calculation of the information entropy for the pattern. As a result, although characteristics corresponding to sufficient conditions for allowing the pattern to be put to practical use have not been clarified, some of the characteristics corresponding to the required conditions for the pattern that can be put to practical use have been made clear. These characteristics will be described below in brief.

(1) The spectrum shows emission lines in the direction of the horizontal axis, which is orthogonal to the flow of the wood grain. The characteristic spread is observed on the opposite sides of the emission lines depending on the arrangement, directionality, and the like of the wood grain. For the wood grain pattern mainly composed of the nodes in the root, the spectrum shows the characteristic spread of the cloud.

For the normal wood grain, the direction of the main component of the force is simply characterized in that the primary direction is orthogonal to the flow of the wood grain.

The variance value for the main component of force is large for a cloud with a large spread. The variance value is largest for an extraordinary wood grain such as one characterized by nodes in a root, and second largest for a noticeable pattern regardless of whether the wood grain is fine or coarse. A pattern surface the color of which is similar to white exhibits a small value. The entropy value also exhibits a corresponding magnitude correlation.

(2) The relationship described in (1) for the intensity of the emission lines, the spread of the cloud and the variance value therefore, and the entropy also applies to spectra obtained for other patterns.

The direction of the main component of force is determined depending on the direction and intensity of the emission lines and the spread of the cloud. In many cases, the direction of the main component of force can be visually estimated. However, in some cases, the direction may only be determined by analysis; characteristics that cannot be visually found in the original image can be determined by analysis.

(3) The characteristic pattern can be estimated based on the classification of the spectrum diagrams. However, for the grain, pearskin finish, abstractive decorative pattern, and the like, the spectrum diagram is not always easy to estimate from the pattern. Thus, the spectrum diagrams for these patterns may be characteristic.

In principle, the spectrum diagram can be inversely transformed into the original pattern. Thus, based on this characteristic, a pattern is expected to be created by producing a spectrum diagram of a characteristic form and inversely transforming the spectrum diagram into the pattern. This is an unprecedented technique and is thus a future challenge.

The conventional process flow relates to the technique of creating, in the computer, a print pattern used for a building material. In this case, the practicality of the created pattern is determined based on the design staff member's sensitivity. The present application presents the introduction of the new technique into the evaluative determination.

The technique uses and applies, for example, the two-dimensional Fourier transformation to a grain expanded over a plane or any other pattern to express the patterns as characteristics in the frequency space. Moreover, the technique of the main component of force analysis is applied to the pattern to determine the characteristic value and the corresponding axis. The results are then associated with the directionality of the pattern in the actual space. Furthermore, the information entropy is determined to estimate a part of the association with the characteristics of the pattern in the actual space.

Utilizing, as a print product, the grain pattern created as the data in the computer as described above is a perfectly new attempt. Unprecedented design patterns are also expected to be created. With neighboring countries improving production techniques thereof, there has been a demand for creation of intellectual assets. In view of the circumstances surrounding Japan, it is timely that organizations having experience in practical techniques cooperate with one another in expanding an invention created by a research organization into a practical technique.

The above-described practical sample patterns are actual patterns provided by various companies. The present inventors appreciate the companies' providing the sample patterns.

### INDUSTRIAL APPLICABILITY

The embodiments of the present invention will be summarized below.

(1) Grain data based on a natural or artificial material for a printing process is replaced with a grain created with the support of the computer based on the creation theory. The grain is incorporated into a housing building material product. Thus, a perfectly new grain can be created, and the in-process delivery period can be reduced.
(2) The grain is created using the branch structure, a kind of geometrical fractal. The generator is interactively created on the computer screen. Based on the generator, the branch portions are repeatedly replaced to construct an element that is to be expanded into a surface. Whether or not the generator is appropriate as the final pattern is determined by the designer, who is an operator, taking the client's demand into account; in this case, the designer performs the operations described below to create the final pattern.
(3) During the replacement of the branch structure, the branches are removed from the initial generator to create a structure corresponding to the generator and having a corrugated shape or the like. By using the structure for the replacement, a new generator can be created in which the corrugated shape is introduced into the element lines of the basic structure of the generator. This provides the pattern with the inherent complicatedness and naturalness of the grain.
(4) The above-described embodiments use the branch structure. However, the present invention is expected to be applicable to various structures.
(5) The lattice points between which the element is buried are set. The lattice points are basically arranged in rectangular form but may be expanded into brick work-like form, rhombus-like form, or the like. The pattern as a whole in which the element is buried between the lattice points arranged in rectangular form is unavoidably very regular. Thus, the swing range with the “1/f fluctuation” characteristic, observed in natural phenomenon, is applied to the lattice points to move the lattice points from the original positions thereof. Thus, the new lattice points are set, and the element is buried between the lattice points to create the entire grain pattern.
(6) The embodiments present the technique of applying the “1/f fluctuation” characteristic.
(7) In order to provide more diverse, complicated, and natural grains, second lattice points are set, and a fluctuation similar to that applied to the initial lattice points is applied to the second lattice points. A discontinuous portion is formed between the first and second lattice points to create the entire pattern.
(8) In order to provide more diverse, complicated, and natural grains, a similar 1/f fluctuation is applied to the length and inclination of the element lines of the generator to obtain an element. The element is buried between the first and second lattice points to which the fluctuation has been applied. Thus, the entire pattern can be created.
(9) The generator and the element can be constructed by providing the element lines corresponding to the stem and branches with the depth information corresponding to the widths of the element lines. This information can be immediately output as film information. Consequently, the information can be used as a material for die creation even though the die creation process is conventional. Alternatively, the information can be converted into CAM information, which can be then input to a machine tool and used for die creation. Since the recent improved techniques have significantly increased the operating speed of the machine tool, the delivery period associated with the die production can be reduced.
(10) The patterns on the surfaces of print materials are decorated with grains so as to give a sense of three-dimensionality. In this case, dies are created to decorate the surface pattern in sync with the print pattern. A plate is produced based on original data obtained from a natural material, an artificial material, the grain to be created, or the like. The plate is then introduced into a print machine for printing. During the printing, the shape in the original data may be changed by permeation of ink, tension applied to base paper during printing, or the like. During die production based on the original data, decoration in sync with the print pattern is difficult. Thus, the original grain data for the die production needs to be modified according to the print pattern. Since the original data is created in the computer, operations required for the modification are easy.
(11) The print material with the grain pattern based on the present invention can be used for a housing building material product, an automotive interior part, an electric home appliance, and information equipment, and for stationeries.

1. A grain pattern for grain pattern printing created by a computer, characterized in that basic structures are repeatedly generated using a geometrical fractal in such a way that the generated basic structures include basic structures of which a repetition mode is changed.

2. The grain pattern for grain pattern printing according to claim 1, characterized in that the basic structures are branch structures, wherein the repetition mode is changed by at least one of single replacement, reverse single replacement, and double replacement corresponding to a combination of the single replacement with the reverse single replacement.

3. The grain pattern for grain pattern printing according to claim 1, characterized in that the basic structures are branch structures, wherein dead-end branch element lines of the branch structures are removed to create a corrugated shape.

4. The grain pattern for grain pattern printing according to claim 1, characterized in that a 1/f fluctuation characteristic is applied to positions of lattice points coupling the basic structures to each other.

5. The grain pattern for grain pattern printing according to claim 1, characterized in that the 1/f fluctuation characteristic is applied to at least one of element line length and element line inclination of each of the basic structures.

6. The grain pattern for grain pattern printing according to claim 1, characterized in that the grain pattern has a width and a depth based on the number of times that the basic structures are superimposed on each other.

7. A method of creating a grain pattern for grain pattern printing using a computer, the method being characterized by comprising:
a base structure generating step of using a geometrical fractal to generate a basic structure; and
a basic structure repeating step of repeatedly generating the basic structures in such a way that the generated basic structures include basic structures of which a repetition mode is changed.

8. The method of creating the grain pattern for grain pattern printing according to claim 7, characterized in that the basic structures are branch structures, wherein the repetition mode is changed by at least one of single replacement, reverse single replacement, and double replacement corresponding to a combination of the single replacement with the reverse single replacement.

9. The method of creating the grain pattern for grain pattern printing according to claim 7, characterized in that dead-end branch element lines of the branch structures are removed to create a corrugated shape.

10. The method of creating the grain pattern for grain pattern printing according to claim 7, characterized in that a 1/f fluctuation characteristic is applied to positions of lattice points coupling the basic structures to each other.

11. The method of creating the grain pattern for grain pattern printing according to claim 7, characterized in that a 1/f fluctuation characteristic is applied to at least one of element line length and element line inclination of each of the basic structures.

12. The method of creating the grain pattern for grain pattern printing according to claim 7, characterized in that the grain pattern has a width and a depth based on the number of times that the basic structures are superimposed on each other.

13. The method of creating the grain pattern for grain pattern printing according to claim 7, characterized in that, in the basic structure generating step, a plurality of types of basic structures are generated and presented so that one or more types of basic structures are selected for use.

14. The method of creating the grain pattern for grain pattern printing according to claim 7, characterized in that, in the basic structure repeating step, a plurality of types of basic structures of which a repetition mode is changed are generated and presented so that one or more types of basic structures of which a repetition mode is changed are selected for use.

15. The method of creating the grain pattern for grain pattern printing according to claim 7, characterized in that the grain pattern created by the creation method is subjected to two-dimensional Fourier transformation to obtain a power spectrum picture, and the power spectrum picture is presented so that the created grain pattern is output, based on a result of evaluation of the power spectrum picture.

16. The method of creating the grain pattern for grain pattern printing according to claim 7, characterized in that information entropy is obtained from the grain pattern created by the creation method, and the information entropy is presented so that the created grain pattern is output, based on a result of evaluation of the information entropy.

17. A program for creating a grain pattern for grain pattern printing, the program making a computer create the grain pattern, the program being characterized by comprising:
a base structure generating step of using a geometrical fractal to generate a basic structure; and
a basic structure repeating step of repeating the generated basic structures in such a way that the generated basic structures include basic structures of which a repetition mode is changed.

18. The program for creating a grain pattern for grain pattern printing according to claim 17, characterized by further comprising:
a step of presenting a plurality of types of basic structures generated in the basic structure generating step; and
a step of inputting a selected type of basic structures.

19. The program for creating a grain pattern for grain pattern printing according to claim 17, characterized by further comprising:
a step of presenting a plurality of types of basic structures of which a repetition mode is changed, which are generated in the basic structure generating step; and
a step of inputting a selected type of basic structures of which a repetition mode is changed.

20. The program for creating a grain pattern for grain pattern printing according to claim 17, characterized by further comprising:
a step of subjecting the grain pattern created by the creation method to two-dimensional Fourier transformation to obtain a power spectrum picture;
a step of presenting the power spectrum picture obtained; and
a step of inputting a result of evaluation of the power spectrum picture,
wherein the created grain pattern is output, based on the evaluation result.

21. The program for creating a grain pattern for grain pattern printing according to claim 17, characterized by further comprising:
a step of obtaining information entropy from the grain pattern created by the creation method;
a step of presenting the information entropy obtained; and
a step of inputting a result of evaluation of the information entropy,
wherein the created grain pattern is output, based on the evaluation result.

22. A housing building material product characterized in that the grain pattern according to claim 1 is printed on the housing building material product.

23. An automotive interior part characterized in that the grain pattern according to claim 1 is printed on the automotive interior part.

24. An electric home appliance characterized in that the grain pattern according to claim 1 is printed on the electric home appliance.

25. Information equipment characterized in that the grain pattern according to claim 1 is printed on the information equipment.
